(19) United States
(12) Patent Application Publication
(10) Pub. No.: US 2026/0219101 A1
(43) Pub. Date: Jul. 30, 2026

(54) MONITORING DEVICE, MONITORING METHOD, AND COMPUTER-READABLE MEDIUM

(71) Applicant: NEC Corporation, Tokyo (JP)

(72) Inventors: Kazuki SEKO, Tokyo (JP); Yohei ITOU, Tokyo (JP); Makoto KATAOKA, Tokyo (JP)

(73) Assignee: NEC Corporation, Tokyo (JP)

(21) Appl. No.: 19/150,570

(22) PCT Filed: Dec. 8, 2023
(86) PCT No.: PCT/JP2023/043927

§ 371 Date: Jul. 24, 2025

(30) Foreign Application Priority Data
Jan. 27, 2023 (JP) 2023-010977

(51) Int. Cl. G01H 9/00; G08B 13/186

(52) U.S. Cl. CPC G01H 9/004; G08B 13/186

(57) ABSTRACT

A monitoring device according to one aspect of the present embodiment includes: at least one memory configured to store instructions; and at least one processor configured to execute the instructions to: acquire vibration occurring in an optical fiber cable; determine whether the vibration is vibration corresponding to reference vibration; and whereby, if the vibration is vibration corresponding to the reference vibration, control notification regarding the source of the vibration on the basis of permission information that is associated with the reference information and indicates whether passage is permitted.

### TECHNICAL FIELD

The present disclosure relates to a monitoring device, a monitoring method, and a program.

### BACKGROUND ART

In recent years, optical fibers have been used not only for communication applications but also as sensors for detecting vibrations generated on the ground.

PTL 1 discloses that two different optical fiber networks detect sensing information on a monitoring target, and an optical fiber sensing system specifies the monitoring target based on two types of detected sensing information. For example, in a case where a person is detected in a second building on the optical fiber network after detecting a person in a first building on the optical fiber network, the optical fiber sensing system can determine whether the person is the same as a previously detected person in the first building.

In addition, PTL 2 discloses a monitoring system that acquires a unique pattern corresponding to a behavior pattern of an authenticated person or vehicle based on an optical signal received from an optical fiber, and specifies the behavior pattern of the authenticated person or vehicle based on the unique pattern. For example, the monitoring system can specify the behavior pattern of the person who has passed through the gate by acquiring the behavior pattern such as the movement trajectory and the gait of the person who has passed through the gate. In addition, in a case where the person who has passed through the gate is authenticated, if the behavior pattern of the person does not match the behavior pattern registered in advance, the monitoring system can notify an alarm.

Further, PTL 3 discloses an optical fiber sensing system that receives an optical signal having a pattern corresponding to a state of a monitoring target from an optical fiber and specifies a position of the monitoring target located around a fence and a trajectory thereof based on the pattern. The sensing system can display an alarm in a case where the monitoring target performs suspicious behavior.

### CITATION LIST

### Patent Literature

PTL 1: WO 2021/070222 A
PTL 2: WO 2020/202694 A
PTL 3: WO 2020/161823 A

### SUMMARY OF INVENTION

### Technical Problem

As an application example of an optical fiber, it is conceivable that an authentication or security system in a predetermined area manages passage of an object such as a person or a vehicle detected by the optical fiber. In a case where this process is executed, the system preferably takes a measure according to whether the authentication or the security target is passable. In PTLs 1 to 3 disclosed above, since the system does not determine whether an object is passable, such problems were not solved. For example, a monitoring system according to PTL 2 determines a behavior pattern of a person after completion of authentication of the person, and does not issue an alarm at an authentication stage.

An object of the present disclosure is to provide a monitoring device, a monitoring method, and a program capable of issuing an alert corresponding to a detected object. It should be noted that this object is merely one of a plurality of objects to be achieved by a plurality of example embodiments disclosed herein. Other objects or problems and novel features will be apparent from the description of the present specification or the accompanying drawings.

### Solution to Problem

A monitoring device according to one example embodiment includes: vibration acquisition means for acquiring first vibration occurring in a first optical fiber cable; determination means for determining whether the first vibration is vibration corresponding to reference vibration; and notification control means for controlling notification regarding a source of the first vibration based on permission information that is associated with the reference information and indicates whether passage is permitted if the first vibration is vibration corresponding to the reference vibration.

A monitoring method according to one example embodiment is executed by a computer, the method includes: acquiring vibration occurring in an optical fiber cable; determining whether the vibration is vibration corresponding to reference vibration; and controlling notification regarding a source of the vibration based on permission information that is associated with the reference information and indicates whether passage is permitted if the vibration is vibration corresponding to the reference vibration.

A program according to one example embodiment causes a computer to execute: acquiring vibration occurring in an optical fiber cable; determining whether the vibration is vibration corresponding to reference vibration; and controlling notification regarding a source of the vibration based on permission information that is associated with the reference information and indicates whether passage is permitted if the vibration is vibration corresponding to the reference vibration.

### Advantageous Effects of Invention

According to the present disclosure, it is possible to provide a monitoring device, a monitoring method, and a program capable of issuing an alert corresponding to a detected object.

### BRIEF DESCRIPTION OF DRAWINGS

FIG. 1 is a block diagram illustrating an example of a monitoring device according to the present disclosure.

FIG. 2 is a flowchart illustrating an example of a representative process of the monitoring device according to the present disclosure.

FIG. 3 is a block diagram illustrating an example of a monitoring system according to the present disclosure.

FIG. 4 is a diagram illustrating an example of a situation in which an optical fiber cable and an authentication gate are provided in the present disclosure.

FIG. 5 is a block diagram illustrating an example of an authentication device according to the present disclosure.

FIG. 6 is a block diagram illustrating an example of a monitoring device according to the present disclosure.

FIG. 7A is a flowchart illustrating an example of a representative process of the monitoring device according to the present disclosure.

FIG. 7B is a flowchart illustrating an example of a representative process of the monitoring device according to the present disclosure.

FIG. 8 is a block diagram illustrating an example of the monitoring system according to the present disclosure.

FIG. 9 is a diagram illustrating an example of a situation in which the optical fiber cable is provided in the present disclosure.

FIG. 10 is a block diagram illustrating an example of the monitoring device according to the present disclosure.

FIG. 11 is a block diagram illustrating an example of the monitoring system according to the present disclosure.

FIG. 12 is a diagram illustrating an example of a situation in which the optical fiber cable is provided in the present disclosure.

FIG. 13 is a block diagram illustrating an example of the monitoring device according to the present disclosure.

FIG. 14 is a diagram illustrating another example of a situation in which the optical fiber cable is provided in the present disclosure.

FIG. 15 is a block diagram illustrating another example of the monitoring device according to the present disclosure.

FIG. 16 is a diagram illustrating an example of a table according to the present disclosure.

FIG. 17 is a block diagram illustrating an example of a hardware configuration of a device according to the present disclosure.

### EXAMPLE EMBODIMENT

Hereinafter, an example embodiment of the present disclosure will be described with reference to the drawings. The following description and drawings in the example embodiment are omitted and simplified as appropriate for clarity of description. Further, in the present disclosure, unless otherwise specified, in a case in which “at least one” is defined for a plurality of items, the definition may mean any one item or may mean any two or more items including all items.

### First Example Embodiment

### [Description of Configuration]

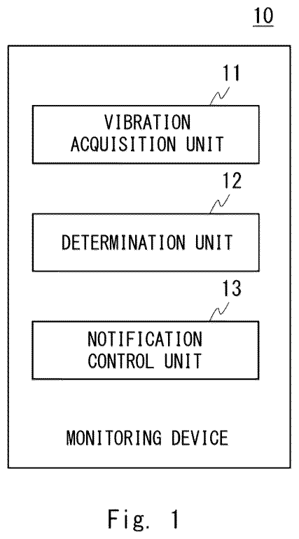

FIG. 1 is a block diagram illustrating an example of the monitoring device. A monitoring device 10 is connected to an optical fiber cable, and includes a vibration acquisition unit 11, a determination unit 12, and a notification control unit 13. As an example, the monitoring device 10 is used for authentication or security in a predetermined area. The predetermined area indicates, for example, the inside of a building, an outdoor region, and the like. Here, the inside of the building may indicate the entire region of the inside of the building, or may indicate a partial region of the inside such as a predetermined floor or a predetermined room of the building.

The monitoring device 10 is displayed as a single computer device in this example, but may be formed as a distributed system having a plurality of computer devices as described later. Each unit of the monitoring device 10 is controlled by a controller of hardware (not illustrated). Each unit will be described below.

The vibration acquisition unit 11 acquires vibration occurring in the optical fiber cable (hereinafter, also referred to as a target optical fiber cable). In a case where an object moves around the optical fiber cable, vibration derived from the object is transmitted to the optical fiber cable, in such a way that characteristics of an optical signal in the optical fiber cable change. The characteristics of the changing optical signal are, for example, a wavelength or amplitude of the optical signal. The vibration acquisition unit 11 can acquire vibration data by acquiring the optical signal.

Note that the target optical fiber cable is laid at an optional place, and it is possible to detect that a person, a vehicle, or the like passes or approaches. The target optical fiber cable may be laid, for example, on a ground or under a floor, around a gate, or on a wall of a building, but the place where the target optical fiber cable is provided is not limited thereto. For example, the target optical fiber cable may be provided on a fence, a guard rail, a support, or the like. The monitoring device 10 is a device that monitors around the target optical fiber cable. The target optical fiber cable detects vibration of a person and acquires gait data of the person based on the detected vibration. In addition, the target optical fiber cable detects vibration of the vehicle and acquires travel data of the vehicle based on the acquired vibration of the vehicle. The vibration of the vehicle is not limited to road noise, and may be vibration generated from an internal combustion engine or a motor. As described above, since the vibration caused by the movement of an object such as a person or a vehicle is different for each object, the object can be identified by the vibration. In addition, the target optical fiber cable can acquire information regarding artificial sound caused by utterance, operation of an object, or the like as vibration.

The determination unit 12 determines whether the vibration acquired by the vibration acquisition unit 11 is vibration corresponding to reference vibration. The reference vibration is associated with permission information indicating permission of passage. The permission information is stored in, for example, a database (not illustrated).

The permission information is, for example, information indicating permission of passage of a reference object that is a source of reference vibration. Here, the reference object is an object that the monitoring device 10 may issue a notification to be described later, for example, an object such as a person or a vehicle. The reference object is an object predicted to move around the target optical fiber cable regardless of whether passage around the target optical fiber cable is permitted. Then, the permission information is information on whether passage of the object around the target optical fiber cable is permitted. The permission information includes, for example, at least one of the following information, but the information included in the permission information is not limited thereto.
(1) Information indicating that passage of an object is permitted
(2) Information indicating that passage of an object is not permitted
(3) Information indicating that passage of an object is permitted under a specific condition, but is not permitted if the specific condition is not satisfied

The specific condition refers to, for example, a condition that, In a case where information indicating permission of passage is presented for an object (hereinafter, also referred to as target object) that is a target of the permission information, the target object is accompanied with another object permitted to pass, or the target object has permission of a surveillance staff. However, the specific condition is not limited thereto.

The reference vibration is vibration used for determination related to execution of notification control. The reference vibration refers to, for example, vibration that is considered to occur at the time that the reference object moves around the target optical fiber cable. Note that the data of the reference vibration may be data of vibration actually generated in the target optical fiber cable at the time that the reference object moves around the target optical fiber cable, or may be data of vibration actually generated by movement of the reference object in an optical fiber cable different from the target optical fiber cable. As another example, data obtained by simulating the movement of the reference object or other types of exemplary data may be used as the reference vibration data. Furthermore, the vibration pattern input by the user may be used as reference vibration data.

Furthermore, the reference vibration data may be data indicating a frequency or amplitude of vibration. In this case, the amount of data to be stored can be reduced as compared with a case where sound data of vibration is stored.

For example, the determination unit 12 may calculate a similarity between the acquired vibration and the reference vibration, and determine that the acquired vibration corresponds to the reference vibration in a case where the similarity is equal to or more than a predetermined threshold value. That is, even if the acquired vibration does not match the reference vibration, the determination unit 12 may determine that the acquired vibration corresponds to the reference vibration in a case where the acquired vibration is similar to the reference vibration to some extent. In the calculation of the similarity, it is possible to apply the calculation of the similarity with respect to the existing waveform, and thus, the detailed description thereof will be omitted here. Here, the fact that the acquired vibration corresponds to the reference vibration means that the source of the acquired vibration can be regarded as a reference object.

In a case where the vibration acquired by the vibration acquisition unit 11 is vibration corresponding to reference vibration, the notification control unit 13 controls the notification related to the source of the vibration based on the permission information associated with the reference vibration. In a case where the permission information is different, the control content of the notification control unit 13 is also different. Hereinafter, specific examples of the permission information and the control contents in response thereto will be described, but examples of the permission information and the control contents in response thereto are not limited thereto.
In a case where the permission information is described above (1): the notification control unit 13 does not perform notification regarding the source of the vibration. Alternatively, the notification control unit 13 makes a notification indicating that the source of the vibration is permitted to pass.
In a case where the permission information is described above (2): the notification control unit 13 performs notification regarding the source of the vibration. Alternatively, the notification control unit 13 makes a notification indicating that the source of the vibration is not permitted to pass.
In a case where the permission information is described above (3): the notification control unit 13 performs notification regarding the source of vibration. This notification is made different from the notification related to (1) or (2). Alternatively, the notification control unit 13 performs a notification indicating that passage of an object that is a source of vibration is permitted under a specific condition, but is not permitted if the specific condition is not satisfied.

If the reference vibration is vibration satisfying a predetermined condition, the permission information may be set as information indicating that passage is permitted. For example, the permission information is set as information indicating that passage of the reference object is permitted. The predetermined condition is, for example, vibration in which reference vibration is stored in a database. In addition, it may be determined that the predetermined condition is satisfied in a case where a vibration pattern in response to a specific sound is included based on the specific sound stored in the database. Note that the predetermined condition is not limited thereto. Specific examples of the predetermined condition will be described in detail in the second and subsequent example embodiments.

The notification control unit 13 is connected to the notification unit, and the notification control unit 13 controls the notification by controlling the operation executed by the notification unit. The method of notification includes any method capable of issuing alert to a surveillance staff that senses the notification unit or an intruder. For example, the notification unit may include at least one of a screen, a speaker, and a vibration device. The notification may be made by display of at least any combination of characters, symbols, or colors on the screen, sound or voice emitted by a speaker, or a vibration pattern. In a case where the notification is changed, the display, sound or voice, or vibration pattern on the screen is changed.

### [Description of Processing Flow]

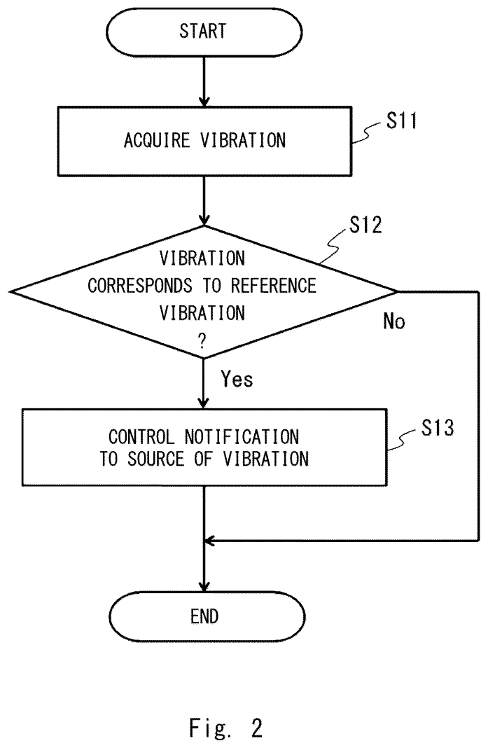

FIG. 2 is a flowchart illustrating an example of representative processing of the monitoring device 10, and an outline of processing of the monitoring device 10 will be described with this flowchart. Since details of each processing are as described above, description thereof is omitted.

First, the vibration acquisition unit 11 acquires vibration occurring in the optical fiber cable (step S11). Next, the determination unit 12 determines whether the vibration is vibration corresponding to the reference vibration (step S12).

In a case where the acquired vibration is vibration corresponding to reference vibration (Yes in step S12), the notification control unit 13 controls the notification related to the source of vibration based on the permission information associated with the reference vibration (step S13). In a case where the acquired vibration is not the vibration corresponding to the reference vibration, the notification control unit 13 does not execute the control of step S13.

Note that a plurality of vibrations may be set as the reference vibration. In this case, the determination unit 12 executes the determination in step S12 for one reference vibration, and in a case where the acquired vibration is vibration corresponding to the reference vibration, the notification control unit 13 executes the process in step S13 based on the permission information associated with the reference vibration. On the other hand, in a case where the acquired vibration is not the vibration corresponding to the reference vibration, the monitoring device 10 may end the process there, or the determination unit 12 may execute the determination in step S12 for another reference vibration. As a result of the determination in step S12, in a case where the acquired vibration is the vibration corresponding to the reference vibration, the process in step S13 is executed. As described above, the monitoring device 10 may continue determination as to whether all or some of the plurality of vibrations that are reference vibrations correspond to the acquired vibration until it is determined that the acquired vibration corresponds to the reference vibration.

In addition, in a case where there is a plurality of vibrations acquired by the vibration acquisition unit 11, the monitoring device 10 may execute the process illustrated in FIG. 2 for each acquired vibration.

### Description of Advantageous Effects

As described above, in a case where the acquired vibration is the vibration corresponding to the reference vibration, the monitoring device 10 controls the notification related to the source of the vibration based on the permission information associated with the reference vibration. For example, the monitoring device 10 can determine that the source of the detected vibration is the reference object, and control the notification based on the permission information. Therefore, the monitoring device 10 can issue an alert corresponding to a detected object.

In addition, in a case where the reference vibration satisfies a predetermined condition and the permission information is information that allows passage, the monitoring device 10 can control the notification related to the source of the vibration based on the permission information. This enables the monitoring device 10 to perform control in such a way that, for an object that satisfies a predetermined condition, a notification is given indicating that the object is permitted to pass.

Note that the process executed by the monitoring device 10 may be shared and executed by a plurality of computer devices. That is, the process of the monitoring device 10 may be achieved by a distributed system.

Here, a method for distributing each unit of the monitoring device 10 to a plurality of computers is optional. As an example, the monitoring device 10 may be configured by mounting the vibration acquisition unit 11 on the first computer, mounting the determination unit 12 and the notification control unit 13 on the second computer, and connecting the first and second computers. As another example, the monitoring device 10 may be configured by mounting the vibration acquisition unit 11, the determination unit 12, and the notification control unit 13 on different computers and connecting the computers.

As still another example, some or all of the units of the monitoring device 10 may be provided in a cloud server constructed on a cloud, or may be provided in another type of virtualization server generated using virtualization technology or the like. Functions other than the functions provided in such a server are disposed at an edge. For example, in a system that monitors a video captured in a site via a network, an edge is a device disposed at the site or near the site, and is a device close to a terminal in a hierarchy of the network.

### Second Example Embodiment

In the following second to fourth example embodiments, a specific example of the monitoring device described in the first example embodiment is disclosed. However, a specific example of the monitoring device illustrated in the first example embodiment is not limited to that described below. In other words, configurations and processes described below are examples, and the present disclosure is not limited thereto. In addition, configurations or processes described in the second to fourth example embodiments described below can be optionally combined.

### (2A)

### [Description of Configuration]

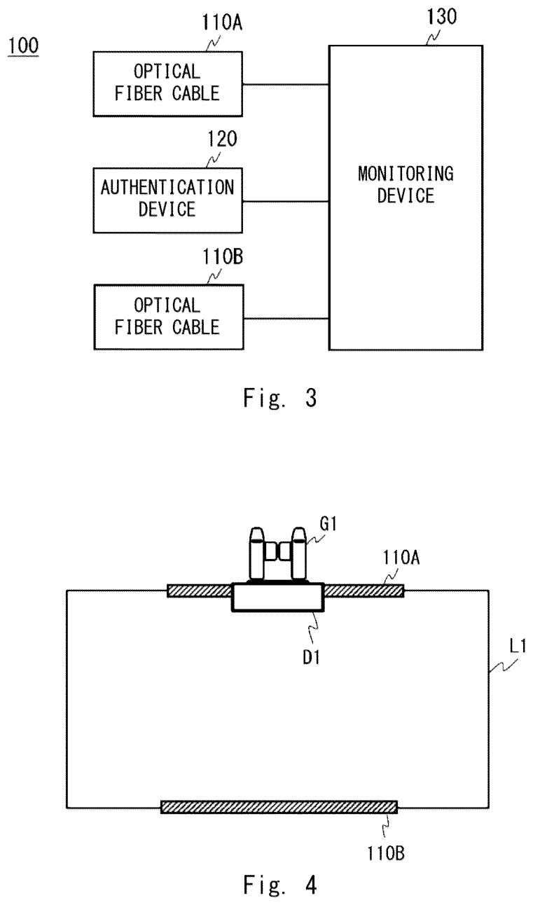

Hereinafter, an example of a monitoring system will be described. A monitoring system 100 illustrated in FIG. 3 includes optical fiber cables 110A and 110B, an authentication device 120, and a monitoring device 130. The optical fiber cables 110A and 110B and the authentication device 120 are connected to the monitoring device 130. Hereinafter, the optical fiber cables 110A and 110B are also collectively referred to as an optical fiber cable 110.

The optical fiber cables 110A and 110B are provided at different positions. As described in the first example embodiment, the vibration generated around the optical fiber cable 110 is acquired by the monitoring device 130.

FIG. 4 is a diagram illustrating an example of a situation in which an optical fiber cable and an authentication gate are provided. FIG. 4 illustrates a state in which an optical fiber cable and an authentication gate are provided around a region L1 where a plurality of doorways are provided. The region L1 is a region where entrance is restricted, and is, for example, a region around a building such as an office building, a laboratory, or a government office.

The region L1 here has a substantially rectangular profile. A person can enter the region L1 from a place where the optical fiber cable 110A is laid on the ground on one side of the outer periphery of the region L1 and a place on the opposite side where the optical fiber cable 110B is laid on the ground. In the region L1, a place around the optical fiber cable 110A is set as an official doorway, and a place around the optical fiber cable 110B is set as a service entrance.

An authentication gate G1 that manages entrance and exit of a person into and from the region L1 is provided around the optical fiber cable 110A, that is, at an official doorway. Therefore, at the time that a person enters the region L1 from the periphery of the optical fiber cable 110A, the person needs to pass through the authentication gate G1.

The authentication gate G1 is a gate whose opening and closing are controlled by the authentication device 120 as described later. The authentication gate G1 is provided with a device that is located outside the authentication gate G1 (that is, the outside of the region L1) and acquires biometric information of a visitor who applies to enter the inside of the region L1. The device is, for example, a camera, a sensor, a speaker, or the like, but is not limited thereto. The authentication gate G1 opens and closes the gate based on a result of biometric authentication performed by the authentication device 120 based on the acquired information. If the gate opens, the visitor can enter the inside of the region L1 through the authentication gate G1, but if the gate remains closed, the visitor cannot enter the inside of the region L1. The biometric information acquired by the authentication gate G1 is one or more optional types of biometric information.

Here, the authentication gate G1 is provided outside the region L1 with respect to the optical fiber cable 110A. Therefore, a person who enters the region L1 through the authentication gate G1 passes through the authentication gate G1 and then passes immediately above the optical fiber cable 110A.

Furthermore, a section D1 around the authentication gate G1 and inside the region L1 is set as a section that is not a target for alert assertion. That is, even if the monitoring device 130 detects that there is a person in the section D1 based on the optical signal of the optical fiber cable 110A, the monitoring device 130 does not issue an alert related to the person. The section D1 includes a region immediately above and in the vicinity of a part of the section in which the optical fiber cable 110A is provided, through which a person passing through the authentication gate G1 is assumed to pass. By setting the section D1 in this way, in a case where the authentication is performed in the authentication gate G1 and the person who is permitted to enter is in the section D1, it is possible to suppress the alarm from being issued to the person. Therefore, it is possible to suppress a situation in which an alert is erroneously issued.

In the following description, a person who is permitted to enter is also referred to as an authorized visitor, and a person who is not permitted to enter is also referred to as an intruder. For example, a staff member of a company or the like, a person who is temporarily permitted to enter the region L1, or the like is assumed as the authorized visitor, but the example of the authorized visitor is not limited thereto. Being able to temporarily enter the region L1 indicates being able to enter the region L1 for an optional period.

On the other hand, no gate is provided in the service entrance around the optical fiber cable 110B. Therefore, it is possible for either an authorized visitor or an intruder to enter the region L1 from the service entrance. However, by the process to be described later, the monitoring device 130 can determine vibration generated from a person around the optical fiber cable 110B and determine whether the person is an authorized visitor or an intruder. If the person is an authorized visitor, the alert is not issued. On the other hand, if the person is an intruder, the alert is issued. Therefore, authentication and security at the service entrance are performed.

Next, details of configurations of the authentication device 120 and the monitoring device 130 will be described.

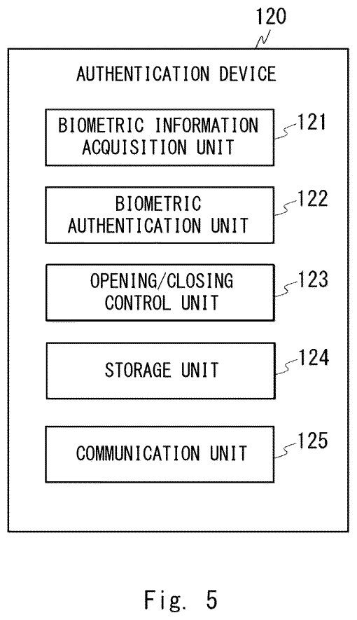

FIG. 5 is a block diagram illustrating an example of the authentication device 120. The authentication device 120 manages the authentication gate G1, and includes a biometric information acquisition unit 121, a biometric authentication unit 122, an opening/closing control unit 123, a storage unit 124, and a communication unit 125. Each unit of the authentication device 120 will be described below.

The biometric information acquisition unit 121 acquires the biometric information of the visitor from the device provided in the authentication gate G1. The biometric information of the visitor is one or more optional types of biometric information of each part of the human body such as a face, an iris, a fingerprint, and a vein. The biometric information can be said to be one type of identification information used for authentication of the visitor.

The biometric authentication unit 122 collates the biometric information acquired by the biometric information acquisition unit 121 with the biometric information of the person who is permitted to enter the region L1 stored in the storage unit 124. Then, if there is biometric information corresponding to the biometric information acquired by the biometric information acquisition unit 121 among the biometric information stored in the storage unit 124, the biometric authentication unit 122 determines that the visitor is permitted. In this case, the biometric authentication unit 122 determines that the authentication is successful. However, if there is no biometric information corresponding to the biometric information acquired by the biometric information acquisition unit 121 among the biometric information stored in the storage unit 124, the biometric authentication unit 122 determines that the visitor is not permitted. In this case, the biometric authentication unit 122 determines that the authentication has failed.

Note that the biometric authentication unit 122 may execute authentication by extracting feature information (for example, a feature amount and a feature vector) from the biometric information acquired by the biometric information acquisition unit 121 and collating the feature information with the feature information stored in the storage unit 124. For example, the biometric authentication unit 122 may calculate the similarity between the feature amount extracted from the acquired biometric information and the feature amount of the person permitted to enter for each person permitted to enter. In a case where there is a similarity equal to or more than the threshold value among the calculated similarities, the biometric authentication unit 122 determines that the entrance of the visitor is permitted. On the other hand, in a case where there is no similarity equal to or more than the threshold value among the calculated similarities, the biometric authentication unit 122 determines that the entrance of the visitor is not permitted.

As another example, the biometric authentication unit 122 may calculate the distance between a feature vector extracted from the acquired biometric information and a feature vector of the person permitted to enter for each person permitted to enter. In a case where there is a distance equal to or more than the threshold value among the calculated distances, the biometric authentication unit 122 determines that the entrance of the visitor is permitted. On the other hand, in a case where there is no distance equal to or more than the threshold value among the calculated distances, the biometric authentication unit 122 determines that the entrance of the visitor is not permitted.

The opening/closing control unit 123 controls opening/closing of the gate of the authentication gate G1. For example, the opening/closing control unit 123 normally keeps the gate closed, and controls the gate to be opened if the biometric authentication unit 122 determines that the authentication is successful.

The storage unit 124 is a database that stores biometric information of a person who is permitted to enter the region L1, the biometric information being used for authentication by the biometric authentication unit 122. Note that the storage unit 124 may store information on a person in association with biometric information on the person. Hereinafter, the information regarding the person is collectively referred to as person information, and the information includes at least one of a name, an ID (identifier), an attribute, a period in which entrance is permitted, and the like of the person. The attribute of the person includes, for example, the position, gender, age, and the like of the person.

Note that the authentication device 120 may further include a notification unit. The notification unit includes at least one of a display unit such as a display and a voice output unit such as a speaker, and notifies the security staff of at least one of the authentication result in the biometric authentication unit 122 and the opening/closing control of the gate in the opening/closing control unit 123. Further, if the authentication in the biometric authentication unit 122 is successful, the notification unit may further notify the person information associated with the biometric information determined to correspond to the biometric information on the visitor.

Note that the authentication device 120 and the authentication gate G1 may execute authentication of the visitor by any of belongings authentication using a certificate or the like or knowledge authentication using a password or the like, instead of biometric authentication. In a case where the belongings authentication or the knowledge authentication is executed, the authentication device 120 collates the information based on the belongings or the knowledge of the visitor acquired from the authentication gate G1 with the information based on the belongings or the knowledge of the person permitted to enter, which is stored in the storage unit 124. If there is information that matches the information acquired from the authentication gate G1 among the information stored in the storage unit 124, the authentication device 120 determines that the entrance of the visitor is permitted. In this case, the authentication succeeds, and opening/closing control unit 123 opens authentication gate G1 to allow the visitor to enter. However, if there is no information that matches the information acquired from the authentication gate G1 among the information stored in the storage unit 124, the authentication device 120 determines that the entrance of the visitor is not permitted. In that case, the authentication fails, and the opening/closing control unit 123 keeps the authentication gate G1 closed. In this manner, authentication is performed by using unique identification information (object information).

As still another example, the authentication device 120 and the authentication gate G1 may execute multi-factor authentication in which two or more of biometric authentication, belongings authentication, and knowledge authentication are combined. If the multi-factor authentication is executed, the authentication device 120 can open the authentication gate G1 and allow the entrance of the visitor if all the authentication executed is successful.

The communication unit 125 executes communication with the monitoring device 130 as necessary.

In addition, the authentication device 120 may store at least one of the authentication result by the biometric authentication unit 122 and the history of opening and closing of the gate in the opening/closing control unit 123 in the storage unit 124. In addition, the stored history may further include person information associated with the biometric information stored in the storage unit 124 corresponding to the biometric information of the person who is permitted to enter in the biometric authentication unit 122. That is, the person information is person information permitted to enter. Furthermore, the stored history information may be displayed as a report on a screen or the like of the authentication device 120 or a terminal connected thereto.

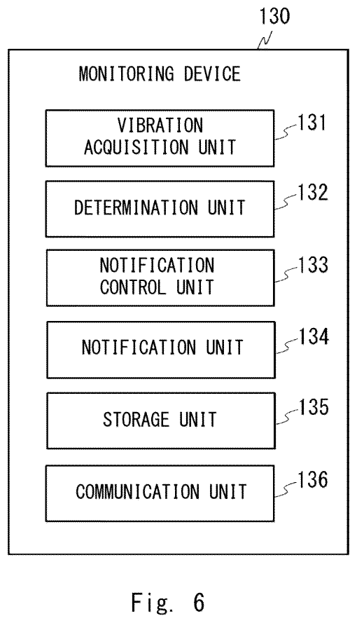

FIG. 6 is a block diagram illustrating an example of the monitoring device 130. The monitoring device 130 includes a vibration acquisition unit 131, a determination unit 132, a notification control unit 133, a notification unit 134, a storage unit 135, and a communication unit 136. The vibration acquisition unit 131, the determination unit 132, and the notification control unit 133 correspond to the vibration acquisition unit 11, the determination unit 12, and the notification control unit 13 in the first example embodiment, respectively. Each unit of the monitoring device 130 will be described below.

The vibration acquisition unit 131 acquires vibration occurring in the optical fiber cable 110 as a vibration acquisition target by the mechanism described in the first example embodiment. Here, the vibration acquisition unit 131 distinguishes vibration occurring in the optical fiber cable 110A from vibration occurring in the optical fiber cable 110B. In a case where the vibration has occurred in the optical fiber cable 110A, the vibration acquisition unit 131 can also detect whether the source of vibration occurred is in the section D1 or in a region other than the section D1. Furthermore, the vibration acquisition unit 131 can also estimate a position of the vibration having occurred in the optical fiber cable.

If the vibration source in which the vibration acquired by the vibration acquisition unit 131 has occurred is in the section D1, the determination unit 132 determines that the vibration is derived from the person who has passed through the authentication gate G1. In this case, the determination unit 132 refers to the storage unit 135 to determine whether the acquired vibration corresponds to any one of the vibrations of the authorized visitor stored in advance. Such a vibration determination process is as described in the first example embodiment, and a detailed description thereof will be omitted.

If the acquired vibration does not correspond to any of the vibrations of the authorized visitor stored in advance, the determination unit 132 updates the storage unit 135 in such a way as to store the acquired vibration in the storage unit 135 as the vibration of the authorized visitor. At this time, the permission information indicating that the entrance of the authorized visitor into the region L1 is permitted is stored in the storage unit 135 in association with the vibration of the authorized visitor. In this manner, the gait data of the authorized visitor is registered in the storage unit 135. On the other hand, in a case where the acquired vibration corresponds to any of the vibrations of the authorized visitor stored in advance, the determination unit 132 ends the process.

In addition, in a case where the acquired vibration in the optical fiber cable 110 satisfies any one of the following conditions, the determination unit 132 executes the determination of the vibration.
(a) A case of vibration occurring in the optical fiber cable 110A, where the vibration has occurred at a position other than the section D1
(b) A case of vibration occurring in the optical fiber cable 110B

That is, if the vibration has occurred at a position other than the section D1, the determination unit 132 executes the determination of the vibration.

If the condition (a) or (b) is satisfied, the determination unit 132 determines whether the acquired vibration corresponds to the vibration of the authorized visitor stored in the storage unit 135. Here, the vibration of the authorized visitor and the authorized visitor correspond to the reference vibration and the reference object in the first example embodiment, respectively. Details of the determination are as described in the first example embodiment, and thus description thereof is omitted.

If the condition (a) or (b) is satisfied with respect to the acquired vibration, the determination unit 132 may determine whether the vibration corresponds to the vibration of the intruder stored in advance in the storage unit 135. If the vibration acquired by the vibration acquisition unit 131 is vibration corresponding to the vibration of the intruder, the determination unit 132 determines that the vibration occurring in the optical fiber cable 110 is derived from the intruder.

In a case where the person who made the acquired vibration occurred is an authorized visitor permitted to enter the region L1, the notification control unit 133 determines that the entrance of the authorized visitor into the region L1 is permitted by referring to the permission information of the authorized visitor. Then, the person is controlled not to be notified in the notification unit 134.

On the other hand, in a case where the person who made the acquired vibration occurred is determined not to be an authorized visitor permitted to enter the region L1, the notification control unit 133 determines that the person is not permitted to enter the region L1. Alternatively, in a case where the person who made the acquired vibration occurred is an intruder who is not permitted to enter the region L1, the notification control unit 133 determines that the entrance of the person into the region L1 is not permitted by referring to the permission information of the intruder. Then, the person who is not permitted to enter is controlled to be notified in the notification unit 134.

The notification unit 134 includes a screen and a speaker, and executes notification according to the notification control unit 133. As described above, in a case where the person who made the acquired vibration occurred is an authorized visitor who is permitted to enter the region L1, notification is not made in the notification unit 134. The notification unit 134 may be provided, for example, in a room where a surveillance staff is present, or may be provided in the region L1 for the notification to an intruder.

On the other hand, if the person who made the acquired vibration occurred is not permitted to enter the region L1, the notification unit 134 performs a notification related to the person under the control of the notification control unit 133. For example, the message “there is a person considered as an intruder” may be displayed on the screen of the notification unit 134. Alternatively, instead of or in addition to the display, a notification with a warning sound or a voice such as “there is a person considered as an intruder” may be made by a speaker.

At this time, the notification unit 134 may also notify the position of vibration estimated by the vibration acquisition unit 131 by either screen display or voice. Furthermore, in a case where the person who made the acquired vibration occurred is an intruder who is not permitted to enter the region L1, the notification unit 134 may also notify the person information of the intruder stored in the storage unit 135 by either screen display or voice.

Note that, in a case where the person who made the acquired vibration occurred is an authorized visitor who is permitted to enter the region L1, the notification control unit 133 may control the notification unit 134 to execute the notification regarding the person. In this case, for example, a display of “there is a person who is considered as an authorized visitor” may be made on the screen of the notification unit 134. At this time, the notification unit 134 may also notify the position of the vibration estimated by the vibration acquisition unit 131 or the person information of the authorized visitor stored in the storage unit 135 by either screen display or voice.

The storage unit 135 is a database in which the vibration of the authorized visitor and the person information of the authorized visitor associated with the vibration are stored. Furthermore, the vibration of the authorized visitor is stored in the storage unit 135 in association with the permission information indicating that entrance of the authorized visitor into the region L1 is permitted. Note that the definition of the person information is as described above, and the description thereof will be omitted.

Furthermore, the storage unit 135 may further store vibration of an intruder who is not permitted to enter the region L1. The vibration of the intruder is stored in the storage unit 135 in association with permission information indicating that the intruder is not permitted to enter the region L1. In addition, the person information of the intruder may be further stored in the storage unit 135 in association with the vibration of the intruder.

### [Description of Processing Flow]

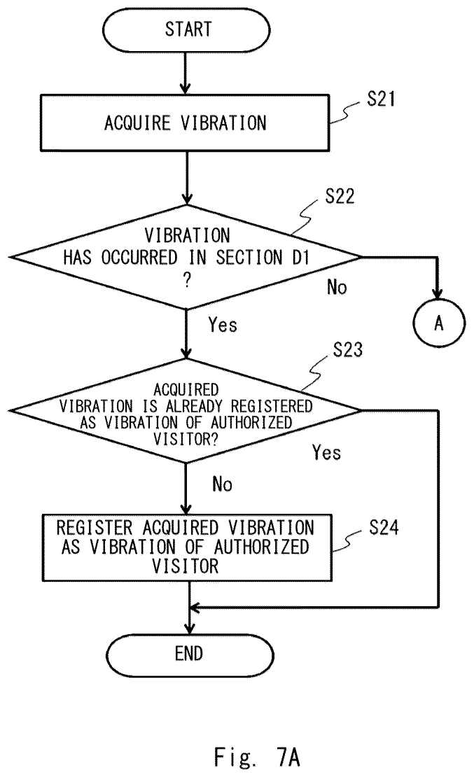

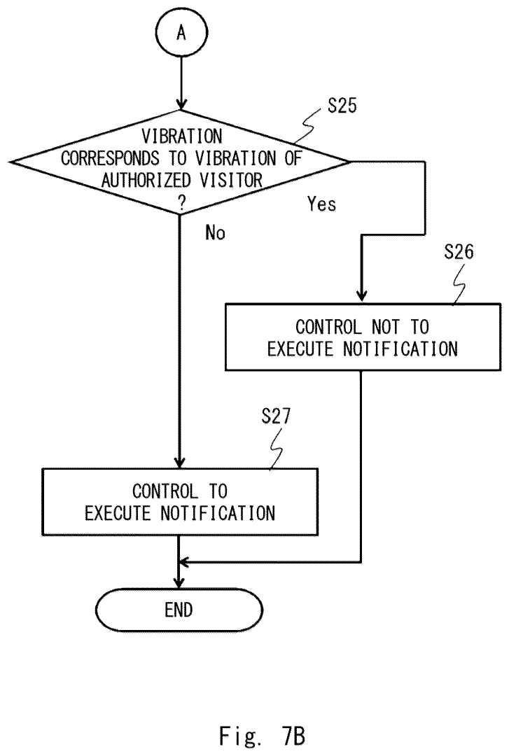

FIGS. 7A and 7B are flowcharts illustrating an example of representative processing of the monitoring device 130, and an outline of processing of the monitoring device 130 will be described with this flowchart. Since details of each processing are as described above, description thereof is omitted.

First, the vibration acquisition unit 131 acquires the vibration occurring in the optical fiber cable 110 (step S21). Here, the determination unit 132 determines whether the acquired vibration has occurred in the section D1 (step S22).

If the acquired vibration has occurred in the section D1 (Yes in step S22), the determination unit 132 refers to the storage unit 135 to determine whether the acquired vibration is already registered in the storage unit 135 as the vibration of the authorized visitor (step S23). If the acquired vibration is already registered in the storage unit 135 as the vibration of the authorized visitor (Yes in step S23), the monitoring device 130 ends the process. On the other hand, if the acquired vibration is not registered in the storage unit 135 as the vibration of the authorized visitor (No in step S23), the determination unit 132 newly registers the vibration as the vibration of the authorized visitor (step S24). Then, the monitoring device 130 ends the process.

If the acquired vibration has occurred at a location other than the section D1 (No in step S22), the determination unit 132 determines whether the vibration corresponds to the vibration of the authorized visitor stored in advance in the storage unit 135 (step S25). In a case where the vibration corresponds to the vibration of the authorized visitor (Yes in step S25), the notification control unit 133 controls the person who made the vibration occurred not to execute the notification in the notification unit 134 (step S26). On the other hand, in a case where the vibration does not correspond to the vibration of the authorized visitor (No in step S25), the notification control unit 133 controls the person who made the vibration occurred to execute the notification in the notification unit 134 (step S27). The notification unit 134 executes notification based on this control.

Note that, as in the description of the first example embodiment, a plurality of vibrations may be set as vibrations of an authorized visitor, or a plurality of vibrations may be acquired by vibration acquisition unit 11. Details of the process executed in such a case are similar to those described in the first example embodiment, and thus description thereof is omitted. Note that, in a case where there is a plurality of vibrations for which an alert is issued, the notification control unit 133 can perform control to execute the notification in the notification unit 134 for each vibration.

### Description of Advantageous Effects

As described above, in a case where the vibration acquired from the optical fiber cable 110 is the vibration of the authorized visitor, the monitoring device 130 performs control in such a way as not to execute the notification in the notification unit 134 for the person who made the vibration occurred. Then, the monitoring device 10 can give a notification in a case where the detected person is not an appropriate person to enter the region L1. Therefore, the monitoring device 130 can issue an alert corresponding to an attribute of the detected person.

In a case where a pedestrian or the like on the outer periphery of a facility or an area is detected using a sensing technology using an optical fiber cable, all persons who have entered the area where the optical fiber cable is laid are detected. In this case, as a result of the detection, an alert is also issued to an authorized visitor permitted to enter the area.

However, in the monitoring device 130, it is possible to accurately determine an intruder to be an alert assertion target by filtering and excluding an authorized visitor from the detected person. As a result, since the alert can be issued only to the intruder, it is possible to efficiently issue the alert in the monitoring device 130 according to the actual situation.

In addition, the vibration acquisition unit 131 can acquire vibration occurring in the optical fiber cable 110A (reference optical fiber cable) different from the optical fiber cable 110B used for determining entrance into the region L1. In particular, in a case where the vibration acquisition unit 131 acquires the vibration occurring in the section D1 of the optical fiber cable 110A, the vibration acquisition unit 131 sets the vibration in the storage unit 135 as the vibration of the authorized visitor. Furthermore, at that time, the permission information indicating that the entrance of the authorized visitor is permitted is also set in the storage unit 135 in association with the vibration. As a result, the monitoring device 130 can detect that the vibration of the authorized visitor has occurred, determine that the authorized visitor has entered the region L1 later, and perform control in such a way as not to issue an alert.

Note that, in (2A), the optical fiber cable 110B or the optical fiber cable 110 (not illustrated) may be set as an optical fiber cable related to an exclusion zone. In a case where a person is present around the optical fiber cable 110B, the vibration acquisition unit 131 stores data of the vibration in the storage unit 135 as vibration of an intruder who is not permitted to enter the region L1. At this time, regarding the vibration of the intruder, the permission information indicating that the entrance of the intruder into the region L1 is not permitted is stored in the storage unit 135 in association with the vibration. Thereafter, in a case where the vibration of the intruder is detected by the optical fiber cable 110, the monitoring device 130 can issue an alert regarding the intruder as described above.

In addition, in a case where the vibration acquisition unit 131 acquires vibration in the section D1 of the optical fiber cable 110A, the determination unit 132 may not execute the determination process on the vibration. As a result, in a case where the occurrence of vibration of the authorized visitor is detected in the optical fiber cable 110A, the monitoring device 130 can perform control in such a way as not to issue an alert to the vibration.

Note that the authentication gate G1 may be provided immediately above the optical fiber cable 110A, or the optical fiber cable 110A may be provided outside the region L1 with respect to the authentication gate G1.

The optical fiber cables 110A and 110B may be separately provided optical fiber cables or may be one optical fiber cable connected to each other.

Instead of the authentication gate G1, a similar facility such as a door for authentication may be provided instead of the authentication gate G1. In addition, the facility similar to the authentication gate G1 is not essential in the example embodiment of (2A). In this case, at the time that the person who has obtained the permission to enter enters the region L1 for the first time, the person walks in the section D1, and as described above, the determination unit 132 stores the vibration in the storage unit 135 as the vibration of the authorized visitor. In this manner, the gait data of the authorized visitor is registered in the storage unit 135.

In the above description, the authentication device 120 and the monitoring device 130 are illustrated as separate devices, but both devices may be provided in the same device. In addition, at least one of the authentication device 120 and the monitoring device 130 may be configured as a distributed system as described in the first example embodiment.

In (2A), the case where the monitoring device 130 is applied to authentication of entrance to a region provided with a plurality of doorways has been described. This region may be not only a region around a building that requires authentication, but also a region where there may be many places serving as entrances in an open space, such as a nature protection zone, a border, or a historic site. In such a region, there is a possibility that an authorized visitor or an intruder enters or exits from a place other than the authorized gate. Even in such a case, by providing the optical fiber cable 110A around the authorized gate and providing the optical fiber cable 110B at a place other than the authorized gate that can be the entrance, the monitoring device 130 can detect a person entering the region with the optical fiber cable. As a result, the monitoring device 130 separates an authorized visitor and an intruder by the above-described process, and operates in such a way as to issue an alert to the intruder and not to issue an alert to the authorized visitor. As a result, it is possible to efficiently issue the alert in the monitoring device 130 according to the actual situation.

The process target described in (2A) can be executed not only for a person but also for a vehicle. In this case, the authentication of the vehicle in the authentication device 120 may be achieved by performing at least one of the biometric authentication, the belongings authentication, and the knowledge authentication on the characters such as the driver of the vehicle. Alternatively, the authentication device 120 may compare a part of the appearance of the vehicle around the authentication gate G1 with a part of the appearance of the vehicle allowed to enter, which is stored in advance in the storage unit 124. A part of the appearance of the vehicle preferably includes a part indicating information considered to be effective for identifying the vehicle, for example, a license plate.

Then, the monitoring device 130 can control notification to the vehicle by executing a process similar to the above for vibration generated in the optical fiber cable 110 by the vehicle.

As described above, the authentication device 120 and the monitoring device 130 can also perform an authentication process and a monitoring process on a target other than the person similar to a case of the person. In addition, the authentication device 120 and the monitoring device 130 may execute the above process for both the person and the vehicle. In the embodiments subsequent to (2B), a person will be described as an example, but it should be noted that the same process as the person can be performed on the vehicle.

### (2B)

In (2A), the vibration of a person detected to be walking in the section D1 is determined to be derived from a person who has passed through the authentication gate G1, and is stored in the storage unit 135 as the vibration of an authorized visitor. However, the person detected to be walking in the section D1 is not only the person who has passed through the authentication gate G1 after being authenticated, but also a person who has passed through the authentication gate G1 without being authenticated. Illegal passing through the authentication gate G1 means, for example, passing over the authentication gate G1. In a case where the person detected as walking in the section D1 is a person who has illegally passed, the person is registered in the storage unit 135 as an authorized visitor. As a result, a problem that the person is permitted to enter the region L1 is assumed.

In (2B), as described below, the person who has illegally passed is not registered in the storage unit 135 as an authorized visitor.

In a case where the authentication in the biometric authentication unit 122 is successful and the gate is controlled to be opened, the communication unit 125 of the authentication device 120 transmits information indicating the fact to the monitoring device 130. In other words, the communication unit 125 transmits information indicating that the authentication is determined to be successful as the information on the person who has passed through. The communication unit 125 can include time information indicating the timing at which the gate is opened in this information.

Furthermore, the vibration acquisition unit 131 can specify the time indicating the timing at which vibration has occurred. It is assumed that the monitoring device 130 receives the information on the person who has passed through the authentication gate G1 and the time information, and the vibration acquisition unit 131 detects the occurrence of the vibration in the section D1 of the optical fiber cable 110A. Here, from the information indicating that the authentication is performed for the authentication gate G1 and the information indicating that the place where the occurrence of the vibration has been detected is the section D1, the vibration acquisition unit 131 determines that the positions where both the events have occurred correspond to each other (that is, the positions are close to each other).

Then, the determination unit 132 can compare the acquired vibration generation time with the time indicating the gate opening timing by referring to the time information. The time information at the time of gate open is transmitted from the authentication device 120 as described above. In a case where the both times coincide with each other or the difference between the both times falls within a predetermined threshold period, the determination unit 132 determines that the vibration occurring in the section D1 is derived from the person who has passed through the authentication gate G1. That is, the determination unit 132 determines that the vibration has occurred in the section D1 by the person who has normally passed through the gate. Alternatively, the determination unit 132 may determine that the vibration occurring in the section D1 is derived from the person who has passed through the authentication gate G1 in a case where the times coincide with each other or in a case where the timing at which the vibration has occurred in the section D1 is later than the timing at which the gate is opened and within a predetermined threshold period.

If the determination unit 132 determines that the vibration occurring in the section D1 is derived from the person who has passed through the authentication gate G1, the determination unit 132 determines that the vibration is derived from the person who has passed through the authentication gate G1. In this case, the determination unit 132 refers to the storage unit 135 to determine whether the acquired vibration corresponds to any one of the vibrations of the authorized visitor stored in advance.

If the acquired vibration does not correspond to any of the vibrations of the authorized visitor stored in advance, the determination unit 132 updates the storage unit 135 in such a way as to store the acquired vibration in the storage unit 135 as the vibration of the authorized visitor. Furthermore, at that time, the permission information indicating that the entrance of the authorized visitor is permitted is also set in the storage unit 135 in association with the vibration. In this way, at the time that the authorized visitor enters through the authentication gate G1, the gait of the authorized visitor is registered in the storage unit 135 in real time. On the other hand, in a case where the acquired vibration corresponds to any of the vibrations of the authorized visitor stored in advance, the determination unit 132 ends the process.

The determination unit 132 performs the vibration determination if one of the conditions (a) and (b) described in (2A) is satisfied. This determination and the subsequent process are as described in (2A), and the description thereof will be omitted.

### Description of Advantageous Effects

As described above, the monitoring device 130 can update the past gait data of the authorized visitor at the time of passing through the gate stored in the storage unit 135 by cooperating with the authentication device 120. As a result, even if the intruder illegally passes through the authentication gate G1 and reaches the section D1, the vibration is not registered as the vibration data of the authorized visitor. Therefore, in a case where the vibration of the intruder is detected by the optical fiber cable 110, an alert can be issued as a result of the determination by the determination unit 132. Therefore, the monitoring device 130 can detect the intruder with higher accuracy.

Specifically, at the time that the person who has passed acquires information indicating that the authentication is determined to be successful as the information (reference object information) related to the person, the monitoring device 130 can set the permission information of the authorized visitor relating to the vibration based on the information. As a result, the monitoring device 130 can accurately set the authorized visitor who does not issue the alert.

In addition, in a case where the vibration in the section D1 is acquired, the determination unit 132 can compare the information of the position and time at which the vibration is acquired with the data of the position and time at which the authentication is successful and the authentication gate G1 is opened. In a case where the two correspond to each other, the determination unit 132 can set the permission information based on the information regarding the person. As a result, the monitoring device 130 can more accurately set the authorized visitor who does not issue the alert.

In the authentication, if the identification information of the person who is permitted to enter the region L1 matches the identification information of the object to be authenticated, the determination unit 132 may newly set information indicating that the person is an object permitted to pass as the permission information. As a result, since the person whose authentication is to be permitted is set as an authorized visitor, the monitoring device 130 can accurately set the authorized visitor.

Furthermore, even in a case where vibration has occurred in the section D1, the determination unit 132 may compare the time of occurrence of the vibration with the time indicating the timing at which the gate is opened, and may cause the determination unit 132 to execute the determination of vibration in a case where the difference between the times is longer than a period of a predetermined threshold value. Alternatively, the determination unit 132 may execute the vibration determination in a case where the difference between the times is longer than the period of the predetermined threshold value, or in a case where the timing at which the vibration has occurred in the section D1 is earlier than the timing at which the gate is opened. As a result, the monitoring device 130 can issue an alert at the time that the intruder illegally passes through the authentication gate G1 and reaches the section D1.

Note that, even for a person who is originally permitted to enter and whose biometric information is stored in the storage unit 124 of the authentication device 120, it is conceivable that the vibration is not stored as the reference vibration in the storage unit 135 of the monitoring device 130. In a case where such a person enters the region L1 from the periphery of the optical fiber cable 110B, the monitoring device 130 determines that the vibration occurring by the person is not the reference vibration, determines that the person is an intruder, and issues an alert.

Therefore, in a case where the person enters the region L1, the person first receives authentication at the authentication gate G1, and passes through the gate. As a result, as described above, the vibration of the person is detected by the optical fiber cable 110A, and the vibration is stored in the monitoring device 130. After this process, even if the person enters the region L1 from the periphery of the optical fiber cable 110B, the monitoring device 130 determines that the vibration emitted by the person is the reference vibration, and determines that the person is an authorized visitor. Therefore, no alert is issued.

Furthermore, the determination unit 132 can determine whether the person has moved from the outside to the inside of the region L1 or whether the person has moved from the inside to the outside of the region L1 by acquiring the time variation of the vibration detected by the optical fiber cable 110. Then, as illustrated in (2A), the determination unit 132 can determine whether the person is an authorized visitor. If the person is an authorized visitor, the communication unit 136 transmits, to authentication device 120, at least one information of the time that the authorized visitor moves from the outside to the inside of region L1 and the time that the authorized visitor moves from the inside to the outside of region L1 together with the information of the authorized visitor. That is, this information indicates an access record of the authorized visitor. The authentication device 120 may record information indicating the access record in the person information of the authorized visitor in the storage unit 124 based on the transmitted information. In this way, the authentication device 120 and the monitoring device 130 can share entrance/exit information of authorized visitors based on an application programming interface (API).

In addition, the person information of the authenticated person may be transmitted from the authentication device 120 to the monitoring device 130. In a case where the transmitted person information includes the period in which the entrance is permitted, the monitoring device 130 compares the information for specifying the person in the transmitted person information with the information for specifying the person in the person information of the authorized visitor stored in the storage unit 135. The information for specifying the person is, for example, information such as a name and an ID. Then, in a case where there is the matched information, the monitoring device 130 may erase or invalidate the person information of the matched authorized visitor and the information of the vibration associated therewith after the lapse of the period in which the entrance is permitted. As a result, even in a case where a person who is no longer permitted to enter enters the region L1, the monitoring device 130 can regard the entrance as unauthorized visitor and issue an alert.

### (2C)

In a case where the notification control unit 133 issues an alert, it is also possible to change a mode of issuing the alert based on the position of the vibration having occurred, estimated by the vibration acquisition unit 131.

For example, the storage unit 135 may store a map indicating the position of the region L1 and the optical fiber cable 110. The notification control unit 133 specifies the position of the vibration having occurred estimated by the vibration acquisition unit 131 on the map. Then, the notification control unit 133 may increase the mode of the alert to be issued as the estimated position of vibration moves inside from the outer periphery of the region L1 (that is, the optical fiber cable 110). That is, in a state in which the position of the estimated vibration is inside the region L1, as the distance between the position and the location on the outer periphery of the region L1 closest to the position increases, the mode of the alert to be issued becomes stronger.

Intensifying the mode of the alert to be issued means making the mode of the alert stronger to give a degree of attention to a person viewing the alert. Examples of enhancing the mode of the alert on the screen include enlarging characters, symbols, and the like used for notification, changing the color used on the screen from a color with low saturation to a color with high saturation, and enlarging a region using a conspicuous color (for example, red). As an example of intensifying the mode of the alert with the voice from the speaker, it is possible to increase the sound or voice, or to output a warning sound from the speaker. However, the example of strengthening the alert mode is not limited thereto.

### Description of Advantageous Effects

As described above, the monitoring device 130 can strengthen the mode of the alert to be issued as the position of the estimated vibration moves inside from the outer periphery of the region L1. As a result, it is possible to more strongly issue an alert to a person having a high degree of intrusion, and thus, it is possible to issue an alert in response to the situation.

Note that, in a case where there is a plurality of vibrations to which the alert is to be issued, the notification control unit 133 can also make the vibration in which the position of the vibration is on the inside from the outer periphery of the region L1 stronger than the vibration in which the position of the vibration is not on the inside and issue the alert.

### Third Example Embodiment

### [Description of Configuration]

Hereinafter, further variations of the present disclosure will be described. In the following embodiments, the description of the matters described in the second example embodiment will be appropriately omitted.

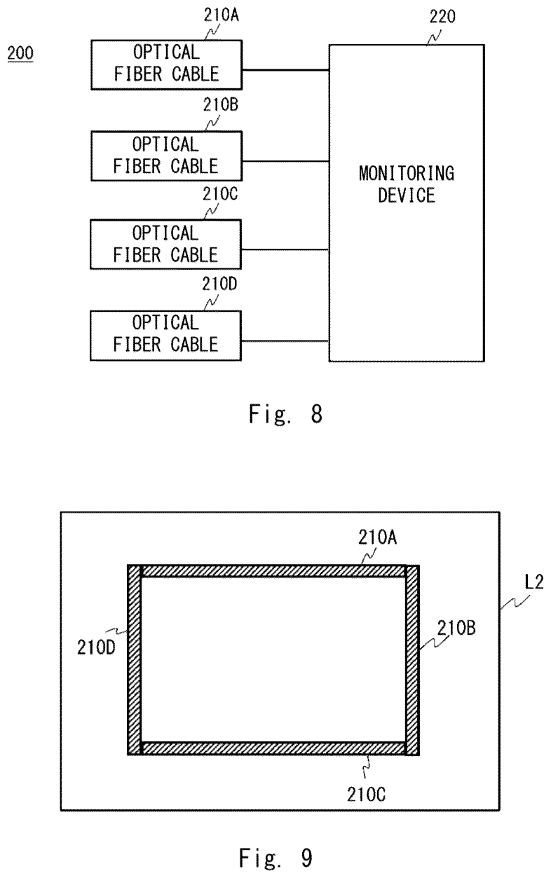

A monitoring system 200 illustrated in FIG. 8 includes optical fiber cables 210A, 210B, 210C, and 210D and a monitoring device 220. The optical fiber cables 210A to 210D are connected to the monitoring device 220. Hereinafter, the optical fiber cables 210A to 210D are also collectively referred to as an optical fiber cable 210.

FIG. 9 is a diagram illustrating an example of a situation in which an optical fiber cable is provided. FIG. 9 illustrates a state in which the optical fiber cables 210A to 210D are provided in the region L2. The region L2 is a region where a facility to be security target is present, and a staff such as a security guard regularly patrol the region L2.

In this example, in the region L2, the optical fiber cables 210A to 210D form a substantially rectangular shape in a connected state. The optical fiber cables 210A to 210D are laid under the ground of a patrol route through which security guards pass on a daily basis. As described later, the monitoring device 220 can manage information indicating whether the security guard goes around the patrol route at authorized time.

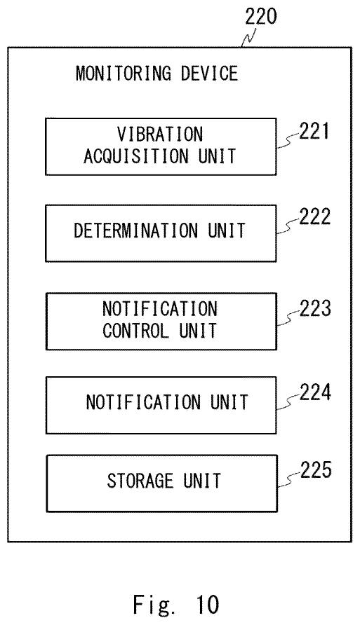

FIG. 10 is a block diagram illustrating an example of the monitoring device 220. The monitoring device 220 includes a vibration acquisition unit 221, a determination unit 222, a notification control unit 223, a notification unit 224, and a storage unit 225. Each unit of the monitoring device 220 will be described below.

The vibration acquisition unit 221 acquires vibration occurring in the optical fiber cable 210 as a vibration acquisition target. Here, the vibration acquisition unit 221 can detect where vibration has occurred in the optical fiber cables 210A to 210D and estimate where vibration has occurred in the optical fiber cables 210A to 210D. Furthermore, the vibration acquisition unit 221 can specify the time indicating the timing at which vibration has occurred.

In a case where the vibration acquisition unit 221 detects vibration, the determination unit 222 collects, over time, a log of the estimated position of the vibration that has occurred and the information of the time that the vibration has occurred for the detected vibration, thereby specifying a route along which the source of the vibration moves. Here, the storage unit 225 may store a map indicating the position of the region L1 and the optical fiber cable 210. The determination unit 222 can specify the moving route of the person of the source of the vibration on the map by using the map.

The determination unit 222 compares the route specified on the map with the route of the security guard stored in advance in the storage unit 225, and determines whether both coincide with each other. The security guard is a person permitted to move in the region L2. For example, the determination unit 222 executes known calculation of the similarity regarding the trajectory data as the degree of matching of the routes, and determines that both coincide if the calculated similarity is equal to or more than a predetermined threshold value. The determination unit 222 determines that the detected vibration is of the security guard if the both coincide with each other, and determines that the detected vibration is not of the security guard if the both do not coincide with each other. If it is determined that the acquired vibration belongs to the security guard, the determination unit 222 collects a log of the moving route and time information on the moving route of the vibration, and stores the log in the storage unit 225.

Further, if it is determined that the acquired vibration is of the security guard, the determination unit 222 stores the acquired vibration of the security guard in the storage unit 225. The determination unit 222 stores permission information indicating that the movement of the security guard in the region L2 is permitted in the storage unit 225 in association with the vibration of the security guard. Further, the person information of the security guard may also be stored in the storage unit 225 in association with the data of the vibration of the security guard. The person information is information as described in (2A).

If the acquired vibration is of the security guard, the notification control unit 223 controls the notification unit 224 not to execute notification of the vibration. On the other hand, if the acquired vibration is not of the security guard, the notification control unit 223 determines that the person is not permitted to enter the region L2. Then, the person who is not permitted to enter is controlled to be notified in the notification unit 224.

The notification unit 224 executes the process described in the second example embodiment based on the control of the notification control unit 223. This will be described below in detail. In addition, the notification unit 224 can appropriately notify the moving route and the time information on the moving route stored in the storage unit 225 by the determination unit 222 as a report. Similar to the notification unit 134, the notification unit 224 may be provided to notify the surveillance staff or may be provided to notify the intruder.

The storage unit 225 stores information on a route of a security guard for comparison and a log of a moving route. Furthermore, vibration of the security guard and information related thereto may be further stored.

### Description of Advantageous Effects

As described above, the monitoring device 220 can determine whether the security guard goes around on the going-around route and store a log of the going-around situation. Therefore, attendance management of the security guard becomes possible. In a case where there are a plurality of security guards, the above process can be executed for each security guard.

In addition, as described below, the monitoring device 220 can acquire data of the vibration of the security guard in real time and use the data for intruder determination, in such a way that the reliability of the security system can be improved.

In a case where the vibration acquisition unit 221 acquires vibration, the determination unit 222 may determine whether the acquired vibration corresponds to any of the vibrations of the security guard stored in the storage unit 225. If the vibration acquired by the vibration acquisition unit 221 does not correspond to any of the stored vibrations of the security guard, the determination unit 222 determines that the vibration occurring in the optical fiber cable 210 is not derived from the security guard. On the other hand, if the vibration acquired by the vibration acquisition unit 221 corresponds to any of the vibrations of the security guard stored in advance, the determination unit 222 determines that the vibration occurring in the optical fiber cable 110 is derived from the security guard.

If the acquired vibration is derived from the security guard stored in advance, the notification control unit 223 determines that the movement of the security guard in the region L2 is permitted by referring to the permission information of the security guard. Then, the person is controlled not to be notified in the notification unit 224.

If it is determined that the person who made the acquired vibration occurred is not a security guard, the notification control unit 223 determines that the person is not permitted to enter the region L2. Then, the person who is not permitted to enter is controlled to be notified in the notification unit 224. This notification method is as described in (2A), and the description thereof will be omitted.

### Fourth Example Embodiment

### (4A)

### [Description of Configuration]

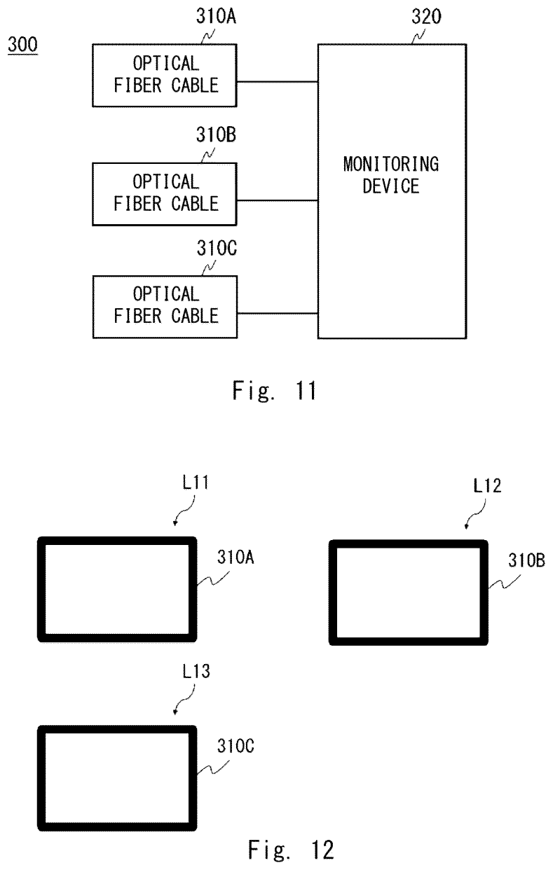

A monitoring system 300 illustrated in FIG. 11 includes optical fiber cables 310A, 310B, and 310C and a monitoring device 320. The optical fiber cables 310A to 310C are connected to the monitoring device 320. Hereinafter, the optical fiber cables 310A to 310C are also collectively referred to as an optical fiber cable 310.

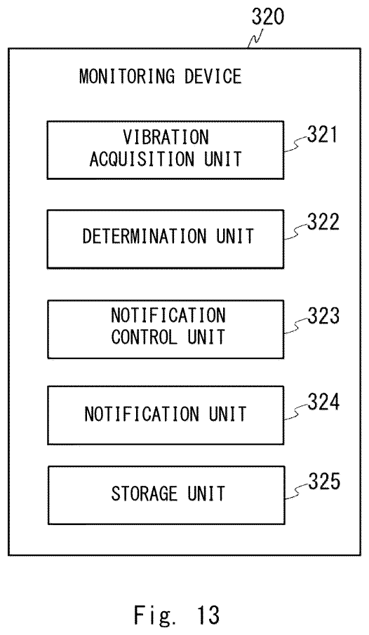

FIG. 12 is a diagram illustrating an example of a situation in which an optical fiber cable is provided. FIG. 12 illustrates a state in which the optical fiber cables 310A to 310C are provided on the outer peripheries of the different regions L11 to L13. The regions L11 to L13 are regions where an authorized visitor can enter but an alert is issued by the monitoring device 320 if an unauthorized person enters. A specific example of such a region is as described in the second example embodiment.

In (4A), the authorized visitor in each of the regions L11 to L13 wears a sound generator that emits a specific sound. Then, the object emits a sound at the timing of being located in the vicinity of the outer periphery of at least the regions L11 to L13.

In this example, the sound generator generates certain electronic sounds outside an audible region. However, the sound generator may be a shoe that emits a specific sound, a portable bell for repelling birds and animals. The sound emitted by the sound generator is preferably a sound outside the audible region that cannot be sensed by humans, but may be a sound within the audible region. In a case where the sound generator emits a sound in the audible region, for example, it is conceivable that the sound to be emitted is a mosquito sound, or the sound emission period is set to be within a predetermined period in such a way as not to be easily noticed by humans. As a result, it is possible to suppress a third party from noticing that security using sound is being executed.

FIG. 13 is a block diagram illustrating an example of the monitoring device 320. The monitoring device 320 includes a vibration acquisition unit 321, a determination unit 322, a notification control unit 323, a notification unit 324, and a storage unit 325. Each unit of the monitoring device 320 will be described below.

The vibration acquisition unit 321 acquires vibration occurring in the optical fiber cable 310 as a vibration acquisition target. Here, the vibration acquisition unit 321 can detect where vibration has occurred in the optical fiber cables 310A to 310C.

The determination unit 322 determines whether the acquired vibration corresponds to the vibration of the authorized visitor stored in the storage unit 325. Here, the data of the vibration of the authorized visitor stored in the storage unit 325 includes data of the vibration related to the specific electronic sound emitted by the sound generator 340. Therefore, the determination unit 322 determines whether the detected vibration corresponds to vibration related to a stored specific electronic sound. In a case where an authorized visitor holding the sound generator 340 enters, the detected vibration includes vibration related to the electronic sound emitted from the sound generator 340. Therefore, the detected vibration corresponds to vibration related to the stored specific electronic sound, and the person who made the acquired vibration occurred is an authorized visitor.

Note that the vibration data related to the specific electronic sound is common for each region. Furthermore, the permission information indicating that the entrance of the authorized visitor into each region is permitted is stored in the storage unit 325 in association with the vibration of the authorized visitor.

In a case where the person who made the acquired vibration occurred is an authorized visitor permitted to enter the region where the optical fiber cable 310 that has detected the vibration is laid, the notification control unit 323 determines that the entrance of the authorized visitor into the region is permitted by referring to the permission information of the authorized visitor. Then, the person is controlled not to be notified in the notification unit 324. In this case, the person who made the acquired vibration occurred emits a specific electronic sound.

On the other hand, in a case where the person who made the acquired vibration occurred is not an authorized visitor permitted to enter the region where the optical fiber cable 310 that has detected the vibration is laid, the notification control unit 323 determines that the person is not permitted to enter the region. Then, the person who is not permitted to enter is controlled to be notified in the notification unit 324. In this case, the person who made the acquired vibration occurred does not emit a specific electronic sound.

The notification unit 324 executes the process described in the second example embodiment based on the control of the notification control unit 323. This will be described below in detail. The notification unit 324 may be provided to notify the surveillance staff or may be provided to notify the intruder.

In the storage unit 325, the vibration and the permission information of the authorized visitor are stored in association with each other. In addition, the person information of the authorized visitor may be further stored.

### Description of Advantageous Effects

As described above, the monitoring device 320 can determine that a person emitting a specific electronic sound is an authorized visitor, and determine that a person not emitting a specific electronic sound is an intruder, and issue an alert to the intruder. As described above, also by using sound for determination, it is possible to efficiently issue the alert in the monitoring device 320 according to the actual situation.

In addition, by making a specific electronic sound a sound outside the audible region, it is possible to suppress a third party from noticing that the sound is used for security. Therefore, security reliability can be improved.

### (4B)

In (4A), a state is assumed in which the sound generator keeps generating sound, or a state is assumed in which a holder of the sound generator, who is an authorized visitor, causes the sound generator to generate sound in the vicinity of the optical fiber cable 310. However, in the former case, the power of the sound generator is consumed quickly, and in the latter case, there is a possibility that the holder may forget to insert the sound generator. In (4B), the occurrence of such a problem can be suppressed.

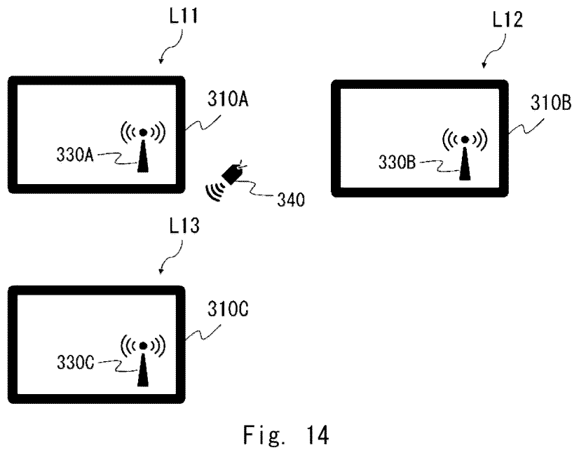

FIG. 14 is a diagram illustrating an example of a situation in which the optical fiber cable is provided. FIG. 14 is different from the configuration illustrated in FIG. 12 in that radio wave transmitters 330A to 330C are provided in regions L11 to L13, respectively. Hereinafter, the radio wave transmitters 330A to 330C are also collectively referred to as a radio wave transmitter 330.

The radio wave transmitter 330 transmits, to the sound generator 340, a signal serving as a trigger for the sound generator 340 to generate sound. Any wireless communication standard such as WiFi (registered trademark) or Bluetooth (registered trademark) can be used for signal transmission. The radio wave transmitter 330 is controlled by the monitoring device 320.

In a case where the sound generator 340 is close to any one of the regions L11 to L13, that is, close to the optical fiber cable 310, the sound generator can receive a signal from the radio wave transmitter 330. Therefore, the sound generator 340 generates a specific electronic sound. The optical fiber cable 110 detects vibration including the electronic sound. The process executed by the monitoring device 320 based on the detected vibration is as described in (4A). Note that the sound generator 340 cannot receive a signal from the radio wave transmitter 330 if it is separated from the optical fiber cable 310. That is, in a case where the holder of the sound generator 340 moves away from the regions L11 to L13, the emission of the sound of the sound generator 340 is stopped.

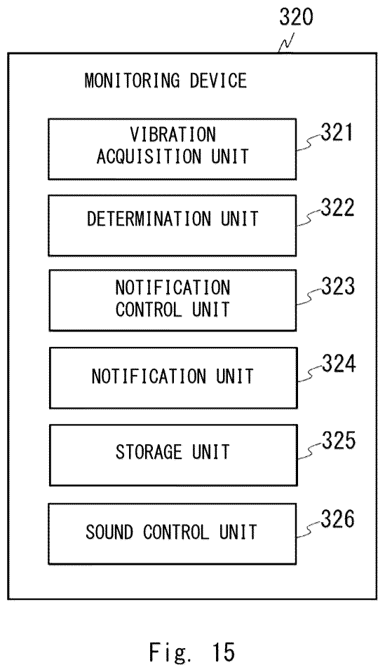

FIG. 15 is a block diagram illustrating an example of the monitoring device 320 in (4B). The monitoring device 320 further includes a sound control unit 326 in addition to the vibration acquisition unit 321 to the storage unit 325. Processes executed by the vibration acquisition unit 321 to the storage unit 325 are similar to those in (4A).

The sound control unit 326 controls the radio wave transmitter 330 in each region to control on/off of signal transmission of the radio wave transmitter 330. By turning on the signal transmission of the radio wave transmitter 330, the optical fiber cable 110 can detect the electronic sound from the sound generator 340 as described above.

### Description of Advantageous Effects

As described above, the sound control unit 326 of the monitoring device 320 can control the sound generator 340 to generate a specific electronic sound in a case where the sound generator 340 is located in the vicinity region of the optical fiber cable 310. As a result, since the sound generator 340 emits sound only if it approaches the regions L11 to L13, the power consumption of the sound generator 340 can be suppressed. In addition, in a case where the sound is generated, it is not necessary for the holder to operate the sound generator 340. Therefore, it is possible to suppress a situation in which the holder who is an authorized visitor forgets the sound generating operation of the sound generator 340 and an alert is issued.

Note that the radio wave transmitter 330 is preferably provided in the vicinity of the optical fiber cable 310 in each region. In this case, at the time that the holder of the sound generator 340 enters the region, the sound generator 340 emits a sound. However, in a case where the holder enters the region and moves away from the optical fiber cable 310, the signal from the radio wave transmitter 330 does not reach the region, in such a way that the sound generator 340 stops emitting sound. In other words, in a case where the sound generator 340 and its holder move to a range where the optical fiber cable 310 does not detect vibration, the sound generator 340 stops emitting sound. Therefore, even in a case where the sound generator 340 is located in a range in which sound emission is unnecessary in the region, the sound emission of the sound generator 340 is stopped, in such a way that the power saving effect of the sound generator 340 can be enhanced.

As another example, the monitoring device 320 may control the sound generation of the sound generator 340 without providing the radio wave transmitter 330 in the region. In this case, the sound generator 340 includes, for example, a GPS (Global Positioning System and Global Positioning Satellite) receiver, and measures the position of the sound generator 340 based on signals received from a plurality of positioning satellites. Note that the sound generator 340 may measure its own position using another type of satellite positioning system instead of the GPS. Instead of or in addition to the GPS receiver, a gyro sensor and an acceleration sensor for measuring a position by dead reckoning may be further used as the sound generator 340. As described above, the sound generator 340 has a function of self-position estimation. The sound generator 340 transmits information on the estimated self-position to the monitoring device 320.

The sound control unit 326 refers to the transmitted position of the sound generator 340 and the positions of the regions L11 to L13 on the map stored in the storage unit 325, and calculates the distance between the position of the sound generator 340 and each of the regions L11 to L13. If necessary, the sound control unit 326 calculates the distance by causing the received position of the sound generator 340 to correspond to the position on the map based on the correspondence relationship between the position measured by the sound generator 340 and the position on the map. If it is determined that the distance between the position of the sound generator 340 and any one of the regions L11 to L13 is equal to or less than the predetermined distance, the radio wave transmitter 330 provided in the region determined to be equal to or less than the predetermined distance is controlled to transmit a signal.

If the distance between the position of the sound generator 340 and the region is larger than a predetermined distance, control is performed in such a way as to stop signal transmission from the radio wave transmitter 330. Such a case includes not only a case where the holder of the sound generator 340 is outside the region but also a case where the holder is inside the region and is separated from the optical fiber cable 310.

Even if the control as described above is executed, even in a case where the sound generator 340 is located in a range in which sound emission is unnecessary in the region, it is possible to stop the sound emission of the sound generator 340. Therefore, the power saving effect of the sound generator 340 can be enhanced. In addition, since the sound control unit 326 can stop the signal transmission of the radio wave transmitter 330 if not necessary, the power saving effect of the radio wave transmitter 330 can be enhanced.

### (4C)

In (4A) and (4B), data common to each region has been used as vibration data related to a specific electronic sound. However, such vibration data may be different depending on the region. Such variations will be described below. Note that the processes illustrated in (4A) and (4B) may be used in combination with the following variations.

The laying state of the optical fiber cable 310 in (4C) is as illustrated in FIG. 12. Here, it is assumed that the regions L11 to L13 are regions of facilities belonging to a certain company, and attributes of persons who can enter the regions L11 to L13 are different. In such a case, in each of the regions L11 to L13, the sound emitted by the sound generator 340 that enables entrance into each of the regions is preferably changed for each of the regions L11 to L13.

Therefore, the staff of the company is equipped with the sound generator 340 that emits different electronic sound patterns for each attribute. As a result, as described later, it is possible to change the region where the staff member can enter according to the attribute. The fact that the patterns of the electronic sounds are different means that the frequencies of the electronic sounds are different in this example, but the example in which the patterns of the electronic sounds are different is not limited thereto.

A block diagram of the monitoring device 320 is as illustrated in FIG. 13. Hereinafter, the process executed by the monitoring device 320 will be described, particularly the differences from (4A), and the description of the points in common with (4A) will be omitted as appropriate.

The vibration acquisition unit 321 acquires vibration occurring in the optical fiber cable 310 as a vibration acquisition target. Here, the vibration acquisition unit 321 can detect where vibration has occurred in the optical fiber cables 310A to 310C.

The determination unit 322 refers to the ID information of each optical fiber cable 310 (or each region) stored in advance in the storage unit 325 and the table having the vibration of the authorized visitor associated with the ID information. Here, data indicating a frequency of a specific electronic sound is associated with the ID information of each optical fiber cable 310 as data related to vibration of an authorized visitor. In addition, the frequency indicated by this table may be associated with permission information of the authorized visitor.

In the table, the frequency associated with each of the optical fiber cables 310A to 310C includes one or more frequencies. In addition, there may be a common frequency between a frequency associated with a certain optical fiber cable 310 and a frequency associated with another optical fiber cable 310. However, the presence or absence of at least one frequency may be different between a frequency associated with a certain optical fiber cable 310 and a frequency associated with another optical fiber cable 310.

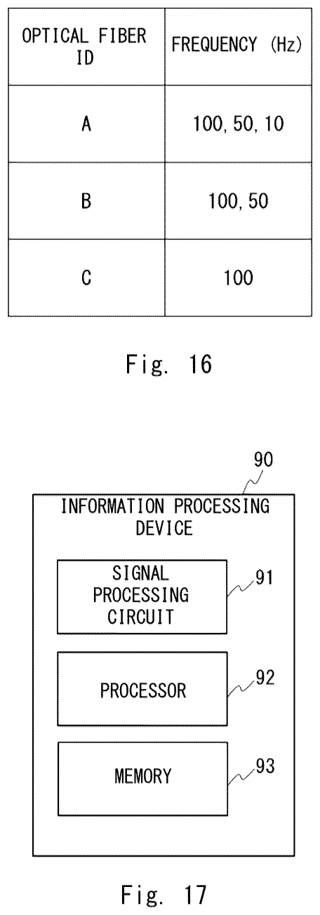

FIG. 16 illustrates an example of such a table. In FIG. 16, IDs of the optical fiber cables 310A to 310C are indicated by A to C. Then, 100, 50, and 10 Hz are set as the frequency for ID:A, 100 and 50 Hz are set as the frequency for ID: B, and 100 Hz is set as the frequency for ID: C. In this case, the holder of the sound generator 340 that emits an electronic sound having a frequency of 100 or 50 Hz can enter a plurality of regions. However, FIG. 16 is merely an example, and only one region number that can be entered for each frequency may be set in the table.

The determination unit 322 specifies the acquired frequency associated with the optical fiber cable in which the vibration has occurred using the table. As an example, in a case where the acquired vibration has occurred in the optical fiber cable 310A, the determination unit 322 specifies the frequency associated with the ID information of the optical fiber cable 310A. Then, the determination unit 322 determines whether the vibration actually detected from the optical fiber cable 310A corresponds to vibration related to the frequency of the optical fiber cable 310A illustrated in the table. With reference to the example of FIG. 16, the determination unit 322 determines whether the vibration actually detected from the optical fiber cable 310A includes vibration of at least one of frequencies of 100, 50, and 10 Hz.

In a case where the vibration actually detected from the optical fiber cable 310A includes vibration at a frequency of at least one of 100, 50, or 10 Hz, the person who made the acquired vibration occurred is an authorized visitor permitted to enter the region where the optical fiber cable 310A is laid. In this case, the notification control unit 323 determines that the entrance of the authorized visitor into the region L11 is permitted by referring to the permission information of the authorized visitor. Then, the person is controlled not to be notified in the notification unit 324.

On the other hand, in a case where the vibration actually detected from the optical fiber cable 310A does not include vibration of any frequency of 100, 50, or 10 Hz, the person who made the acquired vibration occurred is a person who is not permitted to enter the region where the optical fiber cable 310A is laid. In this case, the notification control unit 323 performs control to execute notification in the notification unit 324 for the person who is not permitted to enter.

The notification unit 324 executes the process described in the second example embodiment based on the control of the notification control unit 323. The storage unit 325 stores the table and the permission information of authorized visitors in association with each other. In addition, the person information of the authorized visitor may be further stored.

For example, in the example of FIG. 16, the security staff may have the sound generator 340 that emits the electronic sound of 100 Hz, the general staff may have the sound generator 340 that emits the electronic sound of 50 Hz, and the guest may have the sound generator 340 that emits the electronic sound of 10 Hz. In this case, the security staff can enter any of the regions L11 to L13, but the general staff can enter the regions L11 and L12, and the guest can enter only the region L11. In a case where a general staff member or a guest tries to enter a region where they cannot enter, an alert will be issued.

In addition, in a case where the vibration acquisition unit 321 acquires vibration, the determination unit 322 may determine whether the vibration includes vibration related to any frequency (a frequency of 100, 50 or 10 Hz in the above example) shown in the table. In a case where the acquired vibration does not include vibration related to any frequency, the determination unit 322 determines that an intruder not having the sound generator 340 has intruded into the region. The notification control unit 323 controls the notification unit 324 to notify the intruder.

On the other hand, in a case where the acquired vibration includes vibration related to any frequency, the determination unit 322 specifies the frequency associated with the optical fiber cable 310 in which the vibration is detected in the table as described above. Assuming that the optical fiber cable 310 in which the vibration is detected is the optical fiber cable 310A, the determination unit 322 determines whether the acquired vibration corresponds to the vibration related to the frequency of the optical fiber cable 310A illustrated in the table. The process in the corresponding case is as described above.

In a case where it is determined not to be applicable, the determination unit 322 determines that a person who does not have authority has entered the region. The notification control unit 323 controls the person to execute notification in the notification unit 324. At this time, the notification made by the notification unit 324 may be changed in content from the notification made by the notification unit 324 for the intruder. For example, it is assumed that the notification unit 324 is provided as a speaker in the region. Here, in a case where it is determined that the intruder has intruded into the region, the notification control unit 323 causes the notification unit 324 to output an announcement “do not enter unless you are a staff” by voice. However, in a case where it is determined that a person who does not have authority has entered the region, the notification control unit 323 causes the notification unit 324 to output an announcement of “unauthorized staff is not permitted to enter” by voice.

For example, it is assumed that a general staff equipped with the sound generator 340 that emits an electronic sound of 50 Hz tries to enter the region L13. In this case, the determination unit 322 determines that the general staff is about to enter the region L13 and that the general staff does not have the authority to enter the region L13 based on the acquired vibration. At this time, the notification control unit 323 may cause the notification unit 324 to output an announcement of “do not allow staff other than the security staff to enter” by voice. That is, the notification control unit 323 can control the notification unit 324 in such a way as to notify the attribute of the staff who can enter the target region and notify the content indicating that the person who is about to enter does not have the authority to enter the target region.

The process described above can be executed for each optical fiber cable 310.

### [Description of Advantageous Effects]

In (4C), the monitoring device 320 sets the frequency of the sound generator 340 that can enter the region for each optical fiber cable 310. As a result, it is possible to assign permission or non-permission of entrance to different persons or the like for each region, and it is possible to construct a more sophisticated security system.

Furthermore, even if a person does not have the authority to enter the region, the mode of notification can be changed depending on whether the person is a mere intruder or a staff equipped with a sound generator 340. Therefore, it is possible to cause the person to be notified to accurately recognize his/her own state.

The monitoring device 320 may change the contents described in the table according to the operation of the user. For example, the monitoring device 320 may delete the frequency “100” in ID:A from the table of FIG. 16. In this case, in the state before deletion, the holder of the sound generator 340 that emits an electronic sound having a frequency of 100 Hz does not emit an alert even if the holder enters any of the regions L11, L12, and L13. However, in the state after the deletion, an alert is issued at the time that the holder enters the region L11.

Furthermore, the monitoring device 320 may perform control to change the frequency of the sound to be emitted to the sound generator 340. For example, the storage unit 325 stores the attribute of the person and the ID of the corresponding sound generator 340 in association with each other. In a case where it is desired to change the authority to enter the region for a predetermined attribute, the monitoring device 320 changes the frequency of the sound to be emitted to the sound generator 340 having the ID associated with the predetermined attribute. For example, in the above example, in a case where it is desired to stop the authority of the security staff to enter the region L13, the monitoring device 320 can control the sound generator 340 having the ID corresponding to the security staff in such a way that the sound to be emitted is from 100 Hz to 50 Hz. The monitoring device 320 can perform similar control on the sound generator 340 having an ID corresponding to another attribute. In this manner, the pattern of the sound emitted by the sound generator 340 can be updated.

However, in the monitoring device 320, at least one of the sound patterns emitted from the sound generator 340 having the ID corresponding to the first attribute and the sound generator 340 having the ID corresponding to the second attribute different from the first attribute may be different from each other before and after the above control. As a result, the monitoring device 320 can make the authority to enter the region different for persons having different attributes.

The monitoring device 320 may change at least one of the frequency associated with the optical fiber cable 310 described in the table or the frequency of the sound emitted by the sound generator 340 for a limited period. As a result, for example, it is possible to cause the guest-use sound generator 340 to emit a frequency allowing entry and exit to and from a predetermined region only for a short period of time.

In addition, the electronic sound generated by the sound generator 340 may include not only the electronic sound related to one frequency among the frequencies stored in the table of the storage unit 325 but also electronic sounds related to a plurality of frequencies. In this case, the determination unit 322 determines whether at least one of the frequencies of vibration actually detected from the optical fiber cable 310 corresponds to the vibration of the optical fiber cable 310 illustrated in the table. In a case where at least one of the frequencies of the vibration actually detected from the optical fiber cable 310 corresponds to the vibration of the optical fiber cable 310 illustrated in the table, the person who made the acquired vibration occurred is an authorized visitor. On the other hand, if not, the person who made the acquired vibration occurred is not an authorized visitor. The notification control unit 323 and the notification unit 324 execute the process similar to the above process based on the determination result.

The setting of the frequency of the sound emitted by the sound generator 340 and the table is not limited to the above. For example, in the table, frequencies associated with the optical fiber cables 310A, 310B, and 310C are 100 Hz, 50 Hz, and 10 Hz, respectively. In this case, if the sound generator 340 possessed by the security staff emits an electronic sound including all frequencies of 100, 50, and 10 Hz, the security staff can enter any of the regions L11 to L13. On the other hand, if the sound generator 340 possessed by the general staff emits electronic sounds having frequencies of 100 and 50 Hz, the security staff can enter the regions L11 and L12. In addition, if the sound generator 340 possessed by the guest emits an electronic sound having a frequency of 100 Hz, the security staff can enter only the region L11. As described above, even in a case where the sound generator 340 emits the synthesized sound including a plurality of frequencies, the region where the person can enter can be set for each attribute of the person.

### (4D)

In (4C), the sound generator 340 emits a constant frequency of 1 or more. However, in an actual environment, it is conceivable that a source other than the sound generator 340 emits a sound having a similar frequency. The optical fiber cable 310 also detects such sound as vibration. Therefore, the determination unit 322 may erroneously determine that the sound generator 340 has emitted such a sound that the sound generator 340 has not emitted. In this case, there is a possibility that the alert is not issued to a person who does not originally have the authority to enter the region.

In (4D), in order to suppress the occurrence of such a problem, the sound generator 340 does not emit sound of a constant frequency. Instead, the sound generator 340 emits an electronic sound in which a predetermined pattern of ON and OFF in the sound emission period is changed according to the attribute of the person equipped with the sound generator 340.

The difference from (4C) is that in (4D), in the table stored in the storage unit 325, the ID information of each optical fiber cable 310 is associated with data indicating a specific on/off pattern as data related to the vibration of an authorized visitor.

The determination unit 322 specifies the acquired pattern associated with the optical fiber cable in which the vibration has occurred using the table. Then, the determination unit 322 determines whether the vibration actually detected from the optical fiber cable 310 includes vibration of at least one frequency among one or more patterns associated with the optical fiber cable.

As another example, in a case where the vibration acquisition unit 321 acquires vibration, the determination unit 322 can also determine whether the vibration includes vibration related to any of the patterns shown in the table. In a case where the acquired vibration does not include vibration related to any pattern, the determination unit 322 determines that an intruder not having the sound generator 340 has intruded into the region. On the other hand, in a case where the acquired vibration includes vibration related to any pattern, the determination unit 322 specifies a pattern associated with the optical fiber cable 310 in which vibration is detected in the table as described above. Then, the determination unit 322 determines whether the acquired vibration corresponds to vibration related to the pattern of the optical fiber cable shown in the table.

### Description of Advantageous Effects

The process performed based on the determination result is similar to that in (4C), and thus description thereof is omitted. As described above, the monitoring device 320 can use data indicating a specific on/off pattern instead of the frequency. Therefore, in the monitoring device 320, it is possible to more accurately specify whether a sound is emitted from the sound generator 340. Furthermore, even in a case where the sound generators 340 respectively held by persons having different attributes emit sounds in the same or similar frequency bands, the monitoring device 320 can clearly identify that the two sound generators 340 are different from each other. As a result, since the mode of sound that can be used by the sound generator 340 is widened, the monitoring device 320 can further subdivide and distinguish the holders.

The various variations of (4D) are similar to (4C). For example, the monitoring device 320 can change at least one of the table stored in the storage unit 325 or the pattern of the sound emitted by the sound generator 340. As a result, for example, it is possible to cause the guest-use sound generator 340 to emit a sound having a pattern that allows entry and exit to and from a predetermined region only for a short period of time.

### (4E)

The frequency or on/off pattern shown in (4C) or (4D) may be set differently for each sound generator 340, that is, for each individual having the sound generator 340. The table in which the ID of the sound generator 340 and the pattern are associated with each other is stored in the storage unit 325. The data of this table can be appropriately changed as described above.

In a case where the vibration derived from the sound emitted from the sound generator 340 is detected by the optical fiber cable 310, the determination unit 322 refers to the table and determines that the vibration corresponds to the vibration associated with the ID of the specific sound generator 340. That is, the determination unit 322 determines that the vibration is generated from the person corresponding to the ID.

At this time, the determination unit 322 collects, over time, a log of the estimated position of the vibration that has occurred and the information of the time that the vibration has occurred for the detected vibration, thereby specifying the movement history of the source of the vibration. In the movement history, a time at which an individual enters a certain region and a time at which the individual leaves the region are specified.

Then, based on the movement history, the determination unit 322 can create a report indicating duration time of the specified individual is present in a certain region. This report indicates, for example, a working status of an individual, and can be viewed by an administrator via the notification unit 324. In addition, in a case where a device that manages entrance and exit is connected to the monitoring device 320, the monitoring device 320 may transmit a report content based on the API to the management device. As a result, the management device can also store the report as an access record.

### Description of Advantageous Effects

By creating the report in the system using the sound generator 340, the monitoring device 320 can be used for attendance management of staff.

In the example embodiments described above, the disclosure has been described as a hardware configuration, but the disclosure is not limited thereto. The process (steps) in each device described in the above-described example embodiments of the disclosure can also be achieved by causing a processor in a computer to execute a computer program.

FIG. 17 is a block diagram illustrating a hardware configuration example of the information processing device in which the processing of each example embodiment described above is executed. Referring to FIG. 17, an information processing device 90 includes a signal processing circuit 91, a processor 92, and a memory 93.

The signal processing circuit 91 is a circuit for processing a signal under the control of the processor 92. The signal processing circuit 91 may include a communication circuit that receives a signal from a transmission apparatus.

The processor 92 is connected to the memory 93, and reads and executes a computer program from the memory 93 to execute the process in the device described in the above example embodiments. As an example of the processor 92, one of a central processing unit (CPU), a micro processing unit (MPU), a field-programmable gate array (FPGA), a demand-side platform (DSP), or an application specific integrated circuit (ASIC) may be used, or a plurality of processors may be used in combination.

The memory 93 includes a volatile memory, a nonvolatile memory, or a combination thereof. The number of memories 93 is not limited to one, and a plurality of memories 93 may be provided. The volatile memory may be, for example, a random access memory (RAM) such as a dynamic random access memory (DRAM) or a static random access memory (SRAM). The nonvolatile memory may be, for example, a read-only memory (ROM) such as a programmable random memory (PROM) or an erasable programmable read-only memory (EPROM), a flash memory, or a solid-state drive (SSD).

The memory 93 is used to store one or more instructions. Here, one or more instructions are stored in the memory 93 as a program. The processor 92 can execute the process described in the above example embodiments by reading and executing these programs from the memory 93.

The memory 93 may include a memory built in the processor 92 in addition to a memory provided outside the processor 92. The memory 93 may include a storage disposed away from a processor implementing the processor 92. In this case, the processor 92 can access the memory 93 via an input/output (I/O) interface.

As described above, one or more processors included in each device of the above example embodiments execute one or more programs including a group of instructions for causing a computer to execute an algorithm described with reference to the drawings. By this processing, the information processing method described in each example embodiment may be achieved.

The program described above includes a group of commands or software codes for causing a computer to perform one or more functions described in the example embodiments at the time that the program is read by the computer. The program may be stored in a non-transitory computer-readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, a transitory computer-readable or communication medium includes electrical, optical, acoustic, or other forms of propagated signals.

Some or all of the above-described example embodiments may be described as the following Supplementary Notes, but are not limited to the following Supplementary Notes. Some or all of the elements (for example, configurations and functions) described in Supplementary Notes 2 to 14 dependent on Supplementary Note 1 can also be dependent on Supplementary Notes 16 and 17 by the same dependency relationship as Supplementary Notes 2 to 14. In this way, some or all of the elements described in any Supplementary Note may be applied to various types of hardware, software, recording means for recording software, systems, and methods.

### Supplementary Note 1

A monitoring device including:
vibration acquisition means for acquiring first vibration occurring in a first optical fiber cable;
determination means for determining whether the first vibration is vibration corresponding to reference vibration; and
notification control means for controlling notification regarding a source of the first vibration based on permission information that is associated with the reference information and indicates whether passage is permitted if the first vibration is vibration corresponding to the reference vibration.

### Supplementary Note 2

The monitoring device according to Supplementary Note 1, further including first setting means for setting the permission information as information indicating that passage is permitted if the reference vibration is vibration satisfying a predetermined condition.

### Supplementary Note 3

The monitoring device according to supplementary Note 1 or 2, further including second setting means for, in a case where the vibration acquisition means acquires vibration occurring in a reference optical fiber cable different from the first optical fiber cable, setting the vibration as the reference vibration and setting information, indicating whether a reference object that is a source of the vibration is passable, as the permission information.

### Supplementary Note 4

The monitoring device according to Supplementary Note 3, further including information acquisition means for acquiring reference object information that is information on the reference object,
wherein the second setting means sets the permission information based on the reference object information.

### Supplementary Note 5

The monitoring device according to Supplementary Note 4, wherein the second setting means compares information on a position and time at which the vibration acquisition means has acquired the reference vibration with information on a position and time at which the information acquisition means has acquired the reference object information, and sets the permission information based on the reference object information if both pieces of information correspond to each other.

### Supplementary Note 6

The monitoring device according to Supplementary Note 4 or 5, wherein if the reference object information matches object information of an object to be authenticated, the second setting means newly generates information indicating that the reference object is an object permitted to pass, and sets the information as the permission information.

### Supplementary Note 7

The monitoring device according to any one of Supplementary Notes 3 to 6, wherein in a case where the vibration acquisition means acquires a third vibration occurring in the reference optical fiber cable, the determination means does not determine whether the third vibration is vibration corresponding to the reference vibration.

### Supplementary Note 8

The monitoring device according to Supplementary Note 2, wherein the predetermined condition is that the reference vibration includes vibration related to a specific electronic sound.

### Supplementary Note 9

The monitoring device according to Supplementary Note 8, wherein the specific electronic sound is a sound outside an audible region.

### Supplementary Note 10

The monitoring device according to Supplementary Note 8 or 9, wherein the specific electronic sound includes a specific pattern of sound on and off.

### Supplementary Note 11

The monitoring device according to any one of Supplementary Notes 8 to 10, further including sound control means for controlling the sound generation device to generate the specific electronic sound in a case where the sound generation device that generates the specific electronic sound is located in a vicinity region of the first optical fiber cable.

### Supplementary Note 12

The monitoring device according to any one of Supplementary Notes 8 to 11, wherein
the vibration acquisition means further acquires second vibration occurring in a second optical fiber cable different from the first optical fiber cable,
the determination means determines whether the first vibration includes vibration related to at least one pattern among patterns of a first electronic sound including one or more patterns of electronic sound in a case where the vibration acquisition means acquires the first vibration, and determines whether the second vibration includes vibration related to at least one pattern among patterns of a second electronic sound including one or more patterns of electronic sound and having at least one pattern of electronic sound different from the first pattern of electronic sound in a case where the vibration acquisition means acquires the second vibration, and
the notification control means controls a notification related to a source of the first vibration based on the permission information in a case where the first vibration includes vibration related to at least one pattern among the patterns of the first electronic sound, and controls a notification related to a source of the second vibration based on the permission information in a case where the second vibration includes vibration related to at least one pattern among the patterns of the second electronic sound.

### Supplementary Note 13

The monitoring device according to Supplementary Note 12, wherein
the first setting means assigns a first sound generation device that generates the specific electronic sound to generate at least one of at least one pattern included in the pattern of the first electronic sound or at least one pattern included in the pattern of the second electronic sound, and assigns a second sound generation device that generates the specific electronic sound to generate at least one of at least one pattern included in the pattern of the first electronic sound or at least one pattern included in the pattern of the second electronic sound, and
the pattern assigned to the first sound generation device and the pattern assigned to the second sound generation device are different from each other in at least one pattern.

### Supplementary Note 14

The monitoring device according to Supplementary Note 12 or 13, wherein
the first setting means updates the pattern of the first electronic sound to a pattern of a third electronic sound including one or more patterns of electronic sounds, and updates the pattern of the second electronic sound to a pattern of a fourth electronic sound including one or more patterns of electronic sounds, and
the third electronic sound pattern has at least one electronic sound pattern different from a pattern constituting the first electronic sound pattern, the fourth electronic sound pattern has at least one electronic sound pattern different from a pattern constituting the second electronic sound pattern, and the third electronic sound pattern has at least one electronic sound pattern different from a pattern constituting the fourth electronic sound pattern.

### Supplementary Note 15

A monitoring system including:
the monitoring device according to any one of Supplementary Notes 1 to 14; and
the first optical fiber cable.

### Supplementary Note 16

A monitoring method executed by a computer, the method including:
acquiring vibration occurring in an optical fiber cable;
determining whether the vibration is vibration corresponding to reference vibration; and
controlling notification regarding a source of the vibration based on permission information that is associated with the reference information and indicates whether passage is permitted if the vibration is vibration corresponding to the reference vibration.

### Supplementary Note 17

A program causing a computer to execute:
acquiring vibration occurring in an optical fiber cable;
determining whether the vibration is vibration corresponding to reference vibration; and
controlling notification regarding a source of the vibration based on permission information that is associated with the reference information and indicates whether passage is permitted if the vibration is vibration corresponding to the reference vibration.

The drawings referred to in the above example embodiments are merely examples for describing one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for explaining illustrative example embodiments are not necessarily mandatory, and some features or steps may be omitted. The order of the steps described in any of the figures may be changed as appropriate.

While the present disclosure has been particularly shown and described, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

This application is based upon and claims the benefit of priority from Japanese patent application No. 2023-010977, filed on Jan. 27, 2023, the disclosure of which is incorporated herein in its entirety by reference.

### REFERENCE SIGNS LIST

10 monitoring device
11 vibration acquisition unit
12 determination unit
13 notification control unit
100 monitoring system
110 optical fiber cable
120 authentication device
121 biometric information acquisition unit
122 biometric authentication unit
123 opening/closing control unit
124 storage unit
125 communication unit
130 monitoring device
131 vibration acquisition unit
132 determination unit
133 notification control unit
134 notification unit
135 storage unit
136 communication unit
200 monitoring system
210 optical fiber cable
220 monitoring device
221 vibration acquisition unit
222 determination unit
223 notification control unit
224 notification unit
225 storage unit
300 monitoring system
310 optical fiber cable
320 monitoring device
321 vibration acquisition unit
322 determination unit
323 notification control unit
324 notification unit
325 storage unit
330 radio wave transmitter
340 sound generator

What is claimed is:

1. A monitoring device comprising:
at least one memory configured to store instructions; and
at least one processor configured to execute the instructions to:
acquire first vibration occurring in a first optical fiber cable;
determine whether the first vibration is vibration corresponding to reference vibration; and
control notification regarding a source of the first vibration based on permission information that is associated with the reference information and indicates whether passage is permitted if the first vibration is vibration corresponding to the reference vibration.

2. The monitoring device according to claim 1, wherein the at least one processor is further configured to: set the permission information as information indicating that passage is permitted if the reference vibration is vibration satisfying a predetermined condition.

3. The monitoring device according to claim 1, wherein the at least one processor is further configured to:
set, in a case where the at least one processor acquires vibration occurring in a reference optical fiber cable different from the first optical fiber cable, the vibration as the reference vibration; and
set information, indicating whether a reference object that is a source of the vibration is passable, as the permission information.

4. The monitoring device according to claim 3, wherein the at least one processor is further configured to:
acquire reference object information that is information on the reference object; and
set the permission information based on the reference object information.

5. The monitoring device according to claim 4, wherein the at least one processor is further configured to:
compare information on a position and time at which the at least one processor has acquired the reference vibration with information on a position and time at which the at least one processor has acquired the reference object information; and
set the permission information based on the reference object information if both pieces of information correspond to each other.

6. The monitoring device according to claim 4, wherein if the reference object information matches object information of an object to be authenticated, the at least one processor is further configured to:
newly generate information indicating that the reference object is an object permitted to pass; and
set the information as the permission information.

7. The monitoring device according to claim 3, wherein in a case where the at least one processor acquires a third vibration occurring in the reference optical fiber cable, the at least one processor is further configured to: not determine whether the third vibration is vibration corresponding to the reference vibration.

8. The monitoring device according to claim 2, wherein the predetermined condition is that the reference vibration includes vibration related to a specific electronic sound.

9. The monitoring device according to claim 8, wherein the specific electronic sound is a sound outside an audible region.

10. The monitoring device according to claim 8, wherein the specific electronic sound includes a specific pattern of sound on and off.

11. The monitoring device according to claim 8, wherein the at least one processor is further configured to: control the sound generation device to generate the specific electronic sound in a case where the sound generation device that generates the specific electronic sound is located in a vicinity region of the first optical fiber cable.

12. The monitoring device according to claim 8, wherein the at least one processor is further configured to:
acquire second vibration occurring in a second optical fiber cable different from the first optical fiber cable;
determine whether the first vibration includes vibration related to at least one pattern among patterns of a first electronic sound including one or more patterns of electronic sound in a case where the at least one processor acquires the first vibration;
determine whether the second vibration includes vibration related to at least one pattern among patterns of a second electronic sound including one or more patterns of electronic sound and having at least one pattern of electronic sound different from the first pattern of electronic sound in a case where the at least one processor acquires the second vibration;
control a notification related to a source of the first vibration based on the permission information in a case where the first vibration includes vibration related to at least one pattern among the patterns of the first electronic sound; and
control a notification related to a source of the second vibration based on the permission information in a case where the second vibration includes vibration related to at least one pattern among the patterns of the second electronic sound.

13. The monitoring device according to claim 12, wherein the at least one processor is further configured to:
assign a first sound generation device that generates the specific electronic sound to generate at least one of at least one pattern included in the pattern of the first electronic sound or at least one pattern included in the pattern of the second electronic sound; and
assign a second sound generation device that generates the specific electronic sound to generate at least one of at least one pattern included in the pattern of the first electronic sound or at least one pattern included in the pattern of the second electronic sound, and
the pattern assigned to the first sound generation device and the pattern assigned to the second sound generation device are different from each other in at least one pattern.

14. The monitoring device according to claim 12, wherein the at least one processor is further configured to:
update the pattern of the first electronic sound to a pattern of a third electronic sound including one or more patterns of electronic sounds; and
update the pattern of the second electronic sound to a pattern of a fourth electronic sound including one or more patterns of electronic sounds, and
the third electronic sound pattern has at least one electronic sound pattern different from a pattern constituting the first electronic sound pattern, the fourth electronic sound pattern has at least one electronic sound pattern different from a pattern constituting the second electronic sound pattern, and the third electronic sound pattern has at least one electronic sound pattern different from a pattern constituting the fourth electronic sound pattern.

15. A monitoring system comprising:
the monitoring device according to claim 1; and
the first optical fiber cable.

16. A monitoring method executed by a computer, the method comprising:
acquiring vibration occurring in an optical fiber cable;
determining whether the vibration is vibration corresponding to reference vibration; and
controlling notification regarding a source of the vibration based on permission information that is associated with the reference information and indicates whether passage is permitted if the vibration is vibration corresponding to the reference vibration.

17. The monitoring method executed by the computer according to claim 16, further comprising setting the permission information as information indicating that passage is permitted if the reference vibration is vibration satisfying a predetermined condition.

18. The monitoring method executed by the computer according to claim 16, further comprising:
setting the vibration as the reference vibration in a case where the computer acquires vibration occurring in a reference optical fiber cable different from the optical fiber cable; and
setting information, indicating whether a reference object that is a source of the vibration is passable, as the permission information.

19. The monitoring method executed by the computer according to claim 18, further comprising:
acquiring reference object information that is information on the reference object; and
setting the permission information based on the reference object information.

20. A non-transitory computer-readable medium storing a program causing a computer to execute:
acquiring vibration occurring in an optical fiber cable;
determining whether the vibration is vibration corresponding to reference vibration; and
controlling notification regarding a source of the vibration based on permission information that is associated with the reference information and indicates whether passage is permitted if the vibration is vibration corresponding to the reference vibration.
